(19) United States
(12) Patent Application Publication
(10) Pub. No.: US 2023/0124132 A1
(43) Pub. Date: Apr. 20, 2023

(54) ENHANCED HIGH-VOLTAGE POWER LINE CABLE CONDUCTORS FOR ELECTRIC POWER TRANSMISSION

(71) Applicant: NXP Enhanced Conductor Sciences, LLC, Parker, CO (US)

(72) Inventors: Steven J. Syracuse, Parker, CO (US); Edwin Jacob Goodwin, III, Southlake, TX (US)

(21) Appl. No.: 17/972,544

(22) Filed: Oct. 24, 2022

Related U.S. Application Data
(63) Continuation of application No. 17/725,711, filed on Apr. 21, 2022, now abandoned.
(60) Provisional application No. 63/228,775, filed on Aug. 3, 2021.

(51) Int. Cl. H01B 9/00; H01B 13/00

(52) U.S. Cl. CPC H01B 9/008; H01B 13/0036; H01B 13/0009; H01B 9/006; H01B 1/023

(57) ABSTRACT

High-voltage power line cables for electric power transmission and, in particular, cable conductors for overhead electric power transmission and methods of making such conductors are disclosed. Methods for revamping in-stock and deployed cable conductors for overhead electric power transmission also are disclosed. Each cable conductor has an outermost surface defined by strands that are wrapped around a core of the cable conductor. Indentations are formed in the surfaces of the strands preferably such that an arrangement of dimples extending circumferentially around a longitudinal axis of the cable conductor repeats along a longitudinal direction of the cable conductor. The surface indentations preferably define a dimpled surface of the cable conductor.

### COPYRIGHT STATEMENT

Any new and original work of authorship in this document is subject to copyright protection under the copyright laws of the United States and other countries. Reproduction by anyone of this document as it appears in official governmental records is permitted, but otherwise all other copyright rights whatsoever are reserved.

### BACKGROUND OF THE INVENTION

The invention generally relates to cable conductors and, in particular, to high-voltage power line cable conductors for overhead electric power transmission and methods of making such conductors, as well as methods for revamping in situ cable conductors in overhead electric power transmission systems and methods for revamping cable conductors that are in stock and have yet to be deployed in overhead electric power transmission systems.

Overhead electric power transmission systems are well known and used practically everywhere. FIG. 1 is an illustration of electric power transmission lines 12 extending between electric power transmission towers 14 in a conventional electric power transmission system 10. Such towers 14 also are referred to as tower structures. The towers 14 support transmission tower conductors 16—the energized lines—that conduct electricity. These conductors 16 also are referred to as power lines or cable conductors. A cable conductor 16 typically comprises a plurality of outer strands 18 twisted or wound around a core to form a cable. The conductors 16 can be made from aluminum strands, with a plurality of strands being wound or twisted around a core of inner strands. A conventional and well-known conductor is the stranded 1350-H19 aluminum conductor, which has outer and inner aluminum strands and is an example of an all-aluminum conductor (AAC). The cable conductors also can be made by winding or wrapping aluminum strands around a steel core. Such cable conductors are sometimes referred to as an aluminum conductor, steel-reinforced (or simply ACSR) conductors. An exemplary ACSR conductor 22 is illustrated in FIG. 2. Still further, the cable conductor can be made by winding or wrapping aluminum strands around a core of composite materials. In one type of such conductor the core comprises carbon and glass fibers. Such conductors are sometimes referred to as an aluminum conductor composite core or ACCC conductors. An exemplary ACCC conductor 24 is illustrated in FIG. 3. The core also may include aluminum strands reinforced with alumina ceramic fibers.

With regard to cable conductor winding configurations, there are many. FIGS. 4-17 set forth fourteen exemplary winding configurations. Specifically, FIG. 4 illustrates a conventional cable conductor 32 comprising six outer strands twisted or wound around a single inner strand defining the core of the cable conductor (6:1 winding configuration); FIG. 5 illustrates a conventional cable conductor 34 comprising seven outer strands twisted or wound around a single inner strand defining the core of the cable conductor (7:1 winding configuration); FIG. 6 illustrates a conventional cable conductor 36 comprising eighteen outer strands twisted or wound around a single inner strand defining the core of the cable conductor (18:1 winding configuration); FIG. 7 illustrates a conventional cable conductor 38 comprising six outer strands twisted or wound around a single inner strand defining the core of the cable conductor (36:1 winding configuration); FIG. 8 illustrates a conventional cable conductor 40 comprising twelve outer strands twisted or wound around seven inner strands defining the core of the cable conductor (12:7 winding configuration); FIG. 9 illustrates a conventional cable conductor 42 comprising twenty-four outer strands twisted or wound around seven inner strands defining the core of the cable conductor (24:7 winding configuration); FIG. 10 illustrates a conventional cable conductor 44 comprising twenty-six outer strands twisted or wound around seven inner strands defining the core of the cable conductor (26:7 winding configuration); FIG. 11 illustrates a conventional cable conductor 46 comprising thirty outer strands twisted or wound around seven inner strands defining the core of the cable conductor (30:7 winding configuration); FIG. 12 illustrates a conventional cable conductor 48 comprising forty-five outer strands twisted or wound around seven inner strands defining the core of the cable conductor (45:7 winding configuration); FIG. 13 illustrates a conventional cable conductor 50 comprising seventy-two outer strands twisted or wound around seven inner strands defining the core of the cable conductor (72:7 winding configuration); FIG. 14 illustrates a conventional cable conductor 52 comprising fifty-four outer strands twisted or wound around seven inner strands defining the core of the cable conductor (54:7 winding configuration); FIG. 15 illustrates a conventional cable conductor 54 comprising fifty-four outer strands twisted or wound around nineteen inner strands defining the core of the cable conductor (54:19 winding configuration); FIG. 16 illustrates a conventional cable conductor 56 comprising seventy-six outer strands twisted or wound around nineteen inner strands defining the core of the cable conductor (76:19 winding configuration); and FIG. 17 illustrates a conventional cable conductor 58 comprising eight-four outer strands twisted or wound around nineteen inner strands defining the core of the cable conductor (84:19 winding configuration).

It further is known that cable conductors can be made with the goal of reducing wind drag, which cable conductors can be especially beneficial when used in areas susceptible to hurricanes, tornadoes, or other high winds. For example, with reference to FIGS. 18 and 19 herein, U.S. Pat. No. 4,687,884 discloses and teaches a low drag aerodynamic conductor for overhead transmission that comprises an inner core and a plurality of strands that are helically wound around the core; a winding configuration from the '884 patent is illustrated in FIG. 18 and a portion of an outermost strand from the '884 patent is illustrated in FIG. 19. Each strand that is wound about the core has a trapezoidal cross-sectional shape and fit together to form rings. The outermost strands 60 form an outer surface 62 of the cable conductor. Each outermost strand 60 itself has an outwardly facing surface that is provided with deformations 64 that are spaced along an axial length of the outermost strand 60, as seen in FIG. 19. In a range of Reynolds Numbers representing wind velocities of hurricane proportions, the deformations are purported to effectively reduce the drag of the air moving against and across the cable conductor by ten to fourteen percent over that of a similar cable conductor having an equivalent diameter but with wound strands having an oval cross-sectional shape and no deformations 64.

In another example, U.S. Pat. No. 6,331,677 discloses and teaches an overhead cable conductor that has an outermost surface that is formed by a plurality of outermost strands that fit in interlocking engagement with each other. With reference to FIG. 20, which is a cross-sectional view taken from the '677 patent, the outermost strands 70 define the outermost surface of the cable conductor, and adjoining strands of the outermost strands 70 define a channel or groove 72 that extends an extent along the length of the cable conductor. The groove 72 may be rectangular in cross-section, as illustrated in FIG. 20 hereof. The outermost strands 70 further may include tongue-and-groove mating for secure engagement between the adjoining strands.

Even in view of the forgoing, it is believed that a need exists for further improvement in cable conductors and, in particular, to high-voltage power line cable conductors for overhead electric power transmission. Specifically, it is believed that a need exists for a way to increase the thermal rating of the foregoing types of conductors and lower the operating temperatures of these conductors. It is further believed that a need exists for a way of so revamping cable conductors during manufacturing or—if already manufactured—then prior to deployment, as well as in situ. Such a way would be especially beneficially if such improvement could be achieved without altering emissivity. It is believed that all of this can be achieved by one or more aspects and features of the invention.

### SUMMARY OF THE INVENTION

The invention includes many aspects and features.

In an aspect, a cable conductor for overhead electric power transmission comprises: a core; and a plurality of strands wound around and enclosing the core and defining an outermost, exposed surface of the cable conductor. In this aspect, an outermost surface of each strand comprises an arrangement of surface modifications extending circumferentially around a longitudinal axis of the strand, and this arrangement repeats along a longitudinal axis or direction of the strand. Additionally, the surface modifications preferably comprise indentations.

In a feature of this aspect, a said surface indentation comprises a roundish dent.

In a feature of this aspect, a said surface indentation comprises a concave surface.

In a feature of this aspect, a said surface indentation comprises a dimple.

In a feature of this aspect, the outermost surfaces of the strands consist of dimpled surfaces.

In a feature of this aspect, each arrangement extending circumferentially around the longitudinal axis of a strand consists of three surface indentations.

In a feature of this aspect, each arrangement extending circumferentially around the longitudinal axis of a strand consists of four surface indentations.

In a feature of this aspect, each arrangement extending circumferentially around the longitudinal axis of a strand consists of five surface indentations.

In a feature of this aspect, each arrangement extending circumferentially around the longitudinal axis of a strand consists of ten surface indentations.

In a feature of this aspect, each arrangement extending circumferentially around the longitudinal axis of a strand consists of twenty surface indentations.

In a feature of this aspect, each arrangement extending circumferentially around the longitudinal axis of a strand consists of thirty surface indentations.

In another aspect, a cable conductor for overhead electric power transmission comprises: a core and a plurality of strands wound around and enclosing the core and defining an outermost, exposed surface of the cable conductor, with an outermost surface of each strand consisting of a dimpled surface.

In a feature of this aspect, each strand consists of arrangements of three surface indentations.

In a feature of this aspect, each strand consists of arrangements of four surface indentations.

In a feature of this aspect, each strand consists of arrangements of five surface indentations.

In a feature of this aspect, each strand consists of arrangements of ten surface indentations.

In a feature of this aspect, each strand consists of arrangements of twenty surface indentations.

In a feature of this aspect, each strand consists of arrangements of thirty surface indentations.

In a feature of this aspect, unexposed surfaces of the strands do not have surface indentations.

In a feature of this aspect, unexposed surfaces of the strands are smooth.

In a feature of this aspect, only exposed surfaces of the strands comprise dimpled surfaces.

In a feature of this aspect, only exposed surfaces of the strands have surface indentations.

In another aspect, a cable conductor for overhead electric power transmission comprises: a core; and a plurality of strands wound around and enclosing the core and defining an outermost, exposed surface of the cable conductor. In this aspect, the outermost, exposed surface of the cable conductor comprises an arrangement of surface indentations extending circumferentially around a longitudinal axis of the cable conductor, and the arrangement repeats along an axial or longitudinal direction of the cable conductor.

In a feature of this aspect, a said surface indentation comprises a roundish dent.

In a feature of this aspect, a said surface indentation comprises a concave surface.

In a feature of this aspect, a said surface indentation comprises a dimple.

In a feature of this aspect, outermost surfaces of the strands consist of dimpled surfaces.

In a feature of this aspect, unexposed surfaces of the strands do not have surface indentations.

In a feature of this aspect, unexposed surfaces of the strands are smooth.

In a feature of this aspect, only exposed surfaces of the strands comprise dimpled surfaces.

In a feature of this aspect, only exposed surfaces of the strands have surface indentations.

In another aspect, a cable conductor for overhead electric power transmission comprises: a core and a plurality of strands wound around and enclosing the core and defining an outermost exposed surface of the cable conductor, with the outermost, exposed surface of the cable conductor consisting of dimpled surfaces of the strands.

In a feature of this aspect, outermost surfaces of the strands themselves consist of dimpled surfaces.

In a feature of this aspect, each strand consists of arrangements of three surface indentations.

In a feature of this aspect, each strand consists of arrangements of four surface indentations.

In a feature of this aspect, each strand consists of arrangements of five surface indentations.

In a feature of this aspect, each strand consists of arrangements of ten surface indentations.

In a feature of this aspect, each strand consists of arrangements of twenty surface indentations.

In a feature of this aspect, each strand consists of arrangements of thirty surface indentations.

In a feature of this aspect, unexposed surfaces of the strands do not have surface indentations.

In a feature of this aspect, unexposed surfaces of the strands are smooth.

In a feature of this aspect, only exposed surfaces of the strands comprise dimpled surfaces.

In a feature of this aspect, only exposed surfaces of the strands have surface indentations.

In an aspect, a method of making a cable conductor for overhead electric power transmission comprises: forming surface indentations in an outermost, exposed surface of each of a plurality of strands such that an arrangement of dimples extending circumferentially around a longitudinal axis of the strand repeats along a longitudinal direction of the strand; winding the plurality of strands around a core to form a cable conductor such that the plurality of strands encloses the core and defines an outermost, exposed surface of the cable conductor; and subsequently winding the cable conductor onto a reel.

In a feature of this aspect, a said surface indentation comprises a roundish dent.

In a feature of this aspect, a said surface indentation comprises a concave surface.

In a feature of this aspect, a said surface indentation comprises a dimple.

In a feature of this aspect, the outermost surfaces of the strands themselves consist of dimpled surfaces.

In a feature of this aspect, each arrangement of each strand consists of three surface indentations.

In a feature of this aspect, each arrangement of each strand consists of four surface indentations.

In a feature of this aspect, each arrangement of each strand consists of five surface indentations.

In a feature of this aspect, each arrangement of each strand consists of ten surface indentations.

In a feature of this aspect, each arrangement of each strand consists of twenty surface indentations.

In a feature of this aspect, each arrangement of each strand consists of thirty surface indentations.

In a feature of this aspect, the step of forming surface indentations in the outermost, exposed surfaces of the strands comprises creating dimpled surfaces in the strands.

In another aspect, a method of making a cable conductor for overhead electric power transmission comprises: forming surface indentations in an outermost surface of each of a plurality of strands such that the outermost surface of each strand consists of a dimpled surface; winding the plurality of strands around a core to form a cable conductor such that the plurality of strands encloses the core and defines an outermost, exposed surface of the cable conductor; and subsequently winding the cable conductor onto a reel.

In a feature of this aspect, each strand consists of arrangements of three surface indentations.

In a feature of this aspect, each strand consists of arrangements of four surface indentations.

In a feature of this aspect, each strand consists of arrangements of five surface indentations.

In a feature of this aspect, each strand consists of arrangements of ten surface indentations.

In a feature of this aspect, each strand consists of arrangements of twenty surface indentations.

In a feature of this aspect, each strand consists of arrangements of thirty surface indentations.

In a feature of this aspect, unexposed surfaces of the strands do not have surface indentations.

In a feature of this aspect, unexposed surfaces of the strands are smooth.

In a feature of this aspect, only exposed surfaces of the strands comprise dimpled surfaces.

In a feature of this aspect, only exposed surfaces of the strands have surface indentations.

In an aspect, a method of making a cable conductor for overhead electric power transmission comprises: winding a plurality of strands around a core to form a cable conductor such that the plurality of strands enclose the core and define an outermost, exposed surface of the cable conductor; subsequently forming surface indentations in the outermost, exposed surface of the cable conductor such that an arrangement of dimples extending circumferentially around a longitudinal axis of the cable conductor repeats along a longitudinal direction of the cable conductor; and subsequently winding the cable conductor onto a reel.

In a feature of this aspect, a said surface indentation comprises a roundish dent.

In a feature of this aspect, a said surface indentation comprises a concave surface.

In a feature of this aspect, a said surface indentation comprises a dimple.

In a feature of this aspect, outermost surfaces of the strands consist of dimpled surfaces.

In a feature of this aspect, unexposed surfaces of the strands do not have surface indentations.

In a feature of this aspect, unexposed surfaces of the strands are smooth.

In a feature of this aspect, only exposed surfaces of the strands comprise dimpled surfaces.

In a feature of this aspect, only exposed surfaces of the strands have surface indentations.

In a feature of this aspect, the step of forming surface indentations in the outermost, exposed surfaces of the strands comprises creating dimpled surfaces in the strands.

In an aspect, a method of making a cable conductor for overhead electric power transmission comprises: winding a plurality of strands around a core to form a cable conductor such that the plurality of strands encloses the core and define an outermost, exposed surface of the cable conductor; subsequently forming surface indentations in the outermost, exposed surface of the cable conductor such that the outermost, exposed surface of the cable conductor consists of dimpled surfaces of the strands; and subsequently winding the cable conductor onto a reel.

In a feature of this aspect, outermost surfaces of the strands consist of dimpled surfaces.

In a feature of this aspect, each strand consists of arrangements of three surface indentations.

In a feature of this aspect, each strand consists of arrangements of four surface indentations.

In a feature of this aspect, each strand consists of arrangements of five surface indentations.

In a feature of this aspect, each strand consists of arrangements of ten surface indentations.

In a feature of this aspect, each strand consists of arrangements of twenty surface indentations.

In a feature of this aspect, each strand consists of arrangements of thirty surface indentations.

In a feature of this aspect, unexposed surfaces of the strands do not have surface indentations.

In a feature of this aspect, unexposed surfaces of the strands are smooth.

In a feature of this aspect, only exposed surfaces of the strands comprise dimpled surfaces.

In a feature of this aspect, only exposed surfaces of the strands have surface indentations.

In an aspect, a method of revamping a cable conductor for overhead electric power transmission comprises unwinding a cable conductor from a reel, an outermost surface of the cable conductor being defined by a plurality of strands wound about a core; subsequently forming surface indentations in an outermost surface of each of the plurality of strands such that the outermost surface of each strand consists of a dimpled surface; and subsequently winding the cable conductor onto a reel.

In a feature of this aspect, each strand consists of arrangements of three surface indentations.

In a feature of this aspect, each strand consists of arrangements of four surface indentations.

In a feature of this aspect, each strand consists of arrangements of five surface indentations.

In a feature of this aspect, each strand consists of arrangements of ten surface indentations.

In a feature of this aspect, each strand consists of arrangements of twenty surface indentations.

In a feature of this aspect, each strand consists of arrangements of thirty surface indentations.

In a feature of this aspect, unexposed surfaces of the strands do not have surface indentations.

In a feature of this aspect, unexposed surfaces of the strands are smooth.

In a feature of this aspect, only exposed surfaces of the strands comprise dimpled surfaces.

In a feature of this aspect, only exposed surfaces of the strands have surface indentations.

In an aspect, a method of revamping a cable conductor for overhead electric power transmission comprises: unwinding a cable conductor from a reel, an outermost, exposed surface of the cable conductor being defined by a plurality of strands wound about a core; subsequently forming surface indentations in the outermost, exposed surface of the cable conductor such that the outermost surface of the cable conductor consists of dimpled surfaces; and subsequently winding the cable conductor onto a reel.

In a feature of this aspect, outermost surfaces of the strands consist of dimpled surfaces.

In a feature of this aspect, each strand consists of arrangements of three surface indentations.

In a feature of this aspect, each strand consists of arrangements of four surface indentations.

In a feature of this aspect, each strand consists of arrangements of five surface indentations.

In a feature of this aspect, each strand consists of arrangements of ten surface indentations.

In a feature of this aspect, each strand consists of arrangements of twenty surface indentations.

In a feature of this aspect, each strand consists of arrangements of thirty surface indentations.

In a feature of this aspect, unexposed surfaces of the strands do not have surface indentations.

In a feature of this aspect, unexposed surfaces of the strands are smooth.

In a feature of this aspect, only exposed surfaces of the strands comprise dimpled surfaces.

In a feature of this aspect, only exposed surfaces of the strands have surface indentations.

In an aspect, a method of revamping a cable conductor for overhead electric power transmission comprises: unwinding a cable conductor from a reel, an outermost, exposed surface of the cable conductor being defined by a plurality of strands wound about a core; subsequently forming surface indentations in the outermost, exposed surface of the cable conductor such that an arrangement of dimples extending circumferentially around a longitudinal axis of the cable conductor repeats along a longitudinal direction of the cable conductor; and subsequently winding the cable conductor onto a reel.

In a feature of this aspect, a said surface indentation comprises a roundish dent.

In a feature of this aspect, a said surface indentation comprises a concave surface.

In a feature of this aspect, a said surface indentation comprises a dimple.

In a feature of this aspect, outermost surfaces of the strands consist of dimpled surfaces.

In a feature of this aspect, unexposed surfaces of the strands do not have surface indentations.

In a feature of this aspect, unexposed surfaces of the strands are smooth.

In a feature of this aspect, only exposed surfaces of the strands comprise dimpled surfaces.

In a feature of this aspect, only exposed surfaces of the strands have surface indentations.

In a feature of this aspect, the step of forming surface indentations in the outermost, exposed surfaces of the strands comprises creating dimpled surfaces in the strands.

In an aspect, a method of revamping in situ an electric power transmission line defined by cable conductors each of which has an outermost surface defined by a plurality of strands wrapped around a core, comprises the step of forming a plurality of surface indentations in the strands of the cable conductor such that the outermost surface of each strand consists of a dimpled surface.

In a feature of this aspect, the plurality of surface indentations is formed by moving an apparatus along the electric power transmission line.

In a feature of this aspect, each strand consists of arrangements of three surface indentations.

In a feature of this aspect, each strand consists of arrangements of four surface indentations.

In a feature of this aspect, each strand consists of arrangements of five surface indentations.

In a feature of this aspect, each strand consists of arrangements of ten surface indentations.

In a feature of this aspect, each strand consists of arrangements of twenty surface indentations.

In a feature of this aspect, each strand consists of arrangements of thirty surface indentations.

In a feature of this aspect, unexposed surfaces of the strands do not have surface indentations.

In a feature of this aspect, unexposed surfaces of the strands are smooth.

In a feature of this aspect, only exposed surfaces of the strands comprise dimpled surfaces.

In a feature of this aspect, only exposed surfaces of the strands have surface indentations.

In an aspect, a method of revamping in situ an electric power transmission line defined by cable conductors each of which has an outermost surface defined by a plurality of strands wrapped around a core, comprises the step of forming a plurality of surface indentations in the strands of the cable conductor such that an arrangement of dimples extending circumferentially around a longitudinal axis of the cable conductor repeats along a longitudinal direction of the cable conductor.

In a feature of this aspect, the plurality of surface indentations is formed by moving an apparatus along the electric power transmission line.

In a feature of this aspect, a said surface indentation comprises a roundish dent.

In a feature of this aspect, a said surface indentation comprises a concave surface.

In a feature of this aspect, a said surface indentation comprises a dimple.

In a feature of this aspect, outermost surfaces of the strands consist of dimpled surfaces.

In a feature of this aspect, unexposed surfaces of the strands do not have surface indentations.

In a feature of this aspect, unexposed surfaces of the strands are smooth.

In a feature of this aspect, only exposed surfaces of the strands comprise dimpled surfaces.

In a feature of this aspect, only exposed surfaces of the strands have surface indentations.

In a feature of this aspect, the step of forming surface indentations in the outermost, exposed surfaces of the strands comprises creating dimpled surfaces in the strands.

In an aspect, a method of revamping in situ an electric power transmission line defined by cable conductors each of which has an outermost surface defined by a plurality of strands wrapped around a core, comprises the step of forming a plurality of surface indentations in the strands of the cable conductor such that the outermost surface of the cable conductor consists of dimpled surfaces.

In a feature of this aspect, the plurality of surface indentations is formed by moving an apparatus along the electric power transmission line.

In a feature of this aspect, outermost surfaces of the strands consist of dimpled surfaces.

In a feature of this aspect, each strand consists of arrangements of three surface indentations.

In a feature of this aspect, each strand consists of arrangements of four surface indentations.

In a feature of this aspect, each strand consists of arrangements of five surface indentations.

In a feature of this aspect, each strand consists of arrangements of ten surface indentations.

In a feature of this aspect, each strand consists of arrangements of twenty surface indentations.

In a feature of this aspect, each strand consists of arrangements of thirty surface indentations.

In a feature of this aspect, unexposed surfaces of the strands do not have surface indentations.

In a feature of this aspect, unexposed surfaces of the strands are smooth.

In a feature of this aspect, only exposed surfaces of the strands comprise dimpled surfaces.

In a feature of this aspect, only exposed surfaces of the strands have surface indentations.

In a feature of each of the foregoing aspects relating to methods, the method comprises forming the core as the plurality of strands is wound the core.

In a feature of each of the foregoing aspects relating to methods, the method comprises forming the core before the plurality of strands is wound around the core.

In a feature of each of the foregoing aspects relating to methods, the step of forming surface indentations is performed by impressing.

In a feature of each of the foregoing aspects relating to methods, the step of forming surface indentations is performed by stamping.

In a feature of each of the foregoing aspects relating to methods, the step of forming surface indentations is performed by cutting.

In a feature of each of the foregoing aspects relating to methods, the step of forming surface indentations is performed by etching.

In a feature of each of the foregoing aspects relating to methods, the step of forming surface indentations is performed by shot peening.

In a feature of each of the foregoing aspects relating to methods, the step of forming surface indentations is performed by sandblasting.

In a feature of each of the foregoing aspects relating to methods, the step of forming surface indentations is performed using presses.

In a feature of each of the foregoing aspects relating to methods, the step of forming surface indentations is performed using lasers.

In a feature of each of the foregoing aspects relating to methods, the step of forming surface indentations is performed using chemicals.

In a feature of each of the foregoing aspects relating to methods, the step of forming surface indentations comprises mechanically pressing with an apparatus while transitioning the apparatus along the cable conductor; the apparatus may comprise rollers, rods, multiple presses, and combinations thereof

In a feature of each of the foregoing aspects relating to methods, the step of forming surface indentations comprises mechanically pressing with an apparatus while transitioning the cable conductor through the apparatus; the apparatus may comprise rollers, rods, multiple presses, and combinations thereof.

In a feature of each of the foregoing aspects, exposed surfaces of the strands consist of dimpled surfaces.

In a feature of each of the foregoing aspects, no exposed surface of a strand is smooth.

In a feature of each of the foregoing aspects, the core comprises steel.

In a feature of each of the foregoing aspects, the core comprises aluminum

In a feature of each of the foregoing aspects, the core comprises an aluminum alloy.

In a feature of each of the foregoing aspects, the core comprises aluminum zirconium.

In a feature of each of the foregoing aspects, each surface indentation comprises an oval surface indentation having a diameter-to-depth ratio of 13.5 or less.

In a feature of each of the foregoing aspects, arrangements of surface indentations are aligned relative to each other along the longitudinal direction to form a stack pattern.

In a feature of each of the foregoing aspects, arrangements of surface indentations are offset relative to each other along the longitudinal direction to form a mesh pattern.

In a feature of each of the foregoing aspects, each of arrangements of surface indentations completely encircles the core of the cable conductor.

In a feature of each of the foregoing aspects, a periphery of a surface indentation of an arrangement of surface indentations is located adjacent a respective periphery of each of two other surface indentations of said arrangement, and a periphery of a particular surface indentation of a said arrangement is located adjacent a periphery of only a single surface indentation of each of two other arrangements of surface indentations so as to define a stack pattern.

In a feature of each of the foregoing aspects, a periphery of a surface indentation of an arrangement of surface indentations is located adjacent a respective periphery of each of two other surface indentations of said arrangement, and a periphery of a particular surface indentation of said arrangement is located adjacent a periphery of each of two surface indentations of each of two other arrangements of surface indentations so as to define a mesh pattern.

In addition to the aforementioned aspects and features of the invention, it should be noted that the invention further encompasses the various logical combinations and subcombinations of such aspects and features. Thus, for example, claims in this or a divisional or continuing patent application or applications may be separately directed to any aspect, feature, or embodiment disclosed herein, or combination thereof, without requiring any other aspect, feature, or embodiment.

### BRIEF DESCRIPTION OF THE DRAWINGS

One or more preferred embodiments of the invention now will be described in detail with reference to the accompanying drawings.

FIG. 1 is an illustration of electric power transmission lines extending between electric power transmission towers in a conventional electric power transmission system, wherein an electrical cable conductor in such a system typically comprises a plurality of strands twisted or wound around a core to form the cable conductor.

FIG. 2 is an illustration of a cable conductor of a conventional electric power transmission system, wherein the core of the cable conductor is defined by a plurality of inner strands of steel (also known as a steel-reinforced aluminum conductor, or ACSR conductor).

FIG. 3 is an illustration of a cable conductor of a conventional electric power transmission system, wherein the core of the cable conductor is defined by a composite of carbon and glass fibers (also known as an aluminum conductor composite core, or ACCC conductor).

FIG. 4 is an illustration of a conventional cable conductor comprising six outer strands twisted or wound around a single inner strand defining the core of the cable conductor.

FIG. 5 is an illustration of a conventional cable conductor comprising seven outer strands twisted or wound around a single inner strand defining the core of the cable conductor.

FIG. 6 is an illustration of a conventional cable conductor comprising eighteen outer strands twisted or wound around a single inner strand defining the core of the cable conductor.

FIG. 7 is an illustration of a conventional cable conductor comprising six outer strands twisted or wound around a single inner strand defining the core of the cable conductor.

FIG. 8 is an illustration of a conventional cable conductor comprising twelve outer strands twisted or wound around seven inner strands defining the core of the cable conductor.

FIG. 9 is an illustration of a conventional cable conductor comprising twenty-four outer strands twisted or wound around seven inner strands defining the core of the cable conductor.

FIG. 10 is an illustration of a conventional cable conductor comprising twenty-six outer strands twisted or wound around seven inner strands defining the core of the cable conductor.

FIG. 11 is an illustration of a conventional cable conductor comprising thirty outer strands twisted or wound around seven inner strands defining the core of the cable conductor.

FIG. 12 is an illustration of a conventional cable conductor comprising forty-five outer strands twisted or wound around seven inner strands defining the core of the cable conductor.

FIG. 13 is an illustration of a conventional cable conductor comprising seventy-two outer strands twisted or wound around seven inner strands defining the core of the cable conductor.

FIG. 14 is an illustration of a conventional cable conductor comprising fifty-four outer strands twisted or wound around seven inner strands defining the core of the cable conductor.

FIG. 15 is an illustration of a conventional cable conductor comprising fifty-four outer strands twisted or wound around nineteen inner strands defining the core of the cable conductor.

FIG. 16 is an illustration of a conventional cable conductor comprising seventy-six outer strands twisted or wound around nineteen inner strands defining the core of the cable conductor.

FIG. 17 is an illustration of a conventional cable conductor comprising eighty-four outer strands twisted or wound around nineteen inner strands defining the core of the cable conductor.

FIG. 18 is an illustration of a prior art cable conductor in accordance with the disclosure of U.S. Pat. No. 4,687,884.

FIG. 19 is an illustration of an outer, trapezoidal strand of the conductor of FIG. 18.

FIG. 20 is an illustration of a prior art cable conductor in accordance with the disclosure of U.S. Pat. No. 6,331,677.

FIG. 21 is an illustration of electric power transmission lines extending between electric power transmission towers in an electric power transmission system of a preferred embodiment in accordance with one or more aspects and features of the invention, wherein an outer surface of a cable conductor defined by the exposed, outermost surfaces of the outer strands wound around the core has a plurality of surface indentations.

FIG. 22 is top plan view of a portion of a strand of a cable conductor of a preferred embodiment in accordance with one or more aspects and features of the invention, wherein the strand comprises a circumferential arrangement of three surface indentations in the form of dimples, which circumferential arrangement repeats in a stack pattern.

FIG. 23 is top plan view of a portion of a strand of a cable conductor of a preferred embodiment in accordance with one or more aspects and features of the invention, wherein the strand comprises a circumferential arrangement of three surface indentations in the form of dimples, which circumferential arrangement repeats in a mesh pattern.

FIG. 24 is top plan view of a portion of a strand of a cable conductor of a preferred embodiment in accordance with one or more aspects and features of the invention, wherein the strand comprises a circumferential arrangement of four surface indentations in the form of dimples, which circumferential arrangement repeats in a stack pattern.

FIG. 25 is top plan view of a portion of a strand of a cable conductor of a preferred embodiment in accordance with one or more aspects and features of the invention, wherein the strand comprises a circumferential arrangement of four surface indentations in the form of dimples, which circumferential arrangement repeats in a mesh pattern.

FIG. 26 is top plan view of a portion of a strand of a cable conductor of a preferred embodiment in accordance with one or more aspects and features of the invention, wherein the strand comprises a circumferential arrangement of five surface indentations in the form of dimples, which circumferential arrangement repeats in a stack pattern.

FIG. 27 is top plan view of a portion of a strand of a cable conductor of a preferred embodiment in accordance with one or more aspects and features of the invention, wherein the strand comprises a circumferential arrangement of five surface indentations in the form of dimples, which circumferential arrangement repeats in a mesh pattern.

FIG. 28 is top plan view of a portion of a strand of a cable conductor of a preferred embodiment in accordance with one or more aspects and features of the invention, wherein the strand comprises a circumferential arrangement of ten surface indentations in the form of dimples, which circumferential arrangement repeats in a stack pattern.

FIG. 29 is top plan view of a portion of a strand of a cable conductor of a preferred embodiment in accordance with one or more aspects and features of the invention, wherein the strand comprises a circumferential arrangement of ten surface indentations in the form of dimples, which circumferential arrangement repeats in a mesh pattern.

FIG. 30 is top plan view of a portion of a strand of a cable conductor of a preferred embodiment in accordance with one or more aspects and features of the invention, wherein the strand comprises a circumferential arrangement of twenty surface indentations in the form of dimples, which circumferential arrangement repeats in a stack pattern.

FIG. 31 is top plan view of a portion of a strand of a cable conductor of a preferred embodiment in accordance with one or more aspects and features of the invention, wherein the strand comprises a circumferential arrangement of twenty surface indentations in the form of dimples, which circumferential arrangement repeats in a mesh pattern.

FIG. 32 is top plan view of a portion of a strand of a cable conductor of a preferred embodiment in accordance with one or more aspects and features of the invention, wherein the strand comprises a circumferential arrangement of thirty surface indentations in the form of dimples, which circumferential arrangement repeats in a stack pattern.

FIG. 33 is top plan view of a portion of a strand of a cable conductor of a preferred embodiment in accordance with one or more aspects and features of the invention, wherein the strand comprises a circumferential arrangement of thirty surface indentations in the form of dimples, which circumferential arrangement repeats in a mesh pattern.

FIG. 34 is a chart illustrating projected thermal rating increases versus diameter-to-depth ratios for the cable conductors of FIGS. 22-33.

FIG. 35 is an illustration of a method of manufacturing a cable conductor of a preferred embodiment in accordance with one or more aspects and features of the invention.

FIG. 35a is an illustration of a method of a preferred embodiment in accordance with one or more aspects and features of the invention, which method is similar to that of FIG. 35 but in which a cable conductor that has already been manufactured and is “in stock”, i.e., not yet deployed, is revamped.

FIG. 36 is an illustration of the enhancement processing of the cable conductor performed in the method of FIG. 35.

FIG. 37 is an illustration of additional methods of manufacturing and revamping cable conductors of preferred embodiments in accordance with one or more aspects and features of the invention.

FIG. 37a is an illustration of a first wheel-debossing mechanism utilized in the enhancement processing of FIG. 37.

FIG. 37b is an illustration of a second wheel-debossing mechanism utilized in the enhancement processing of FIG. 37.

FIG. 38 is an illustration of additional methods of manufacturing and revamping cable conductors of preferred embodiments in accordance with one or more aspects and features of the invention.

FIG. 38a is an illustration of a stamping mechanism utilized in the enhancement processing of FIG. 38, wherein the stamping mechanism is in a first position for acting upon the cable conductor.

FIG. 38b is another illustration of the stamping mechanism utilized in the enhancement processing of FIG. 38, wherein the stamping mechanism is in a second position in which it acts upon the cable conductor.

FIG. 38c is yet another illustration of the stamping mechanism utilized in the enhancement processing of FIG. 38, wherein the stamping mechanism—now having acted upon the cable conductor—has returned to the first position.

FIG. 39 is an illustration of yet additional methods of manufacturing and revamping cable conductors of additional preferred embodiments in accordance with one or more aspects and features of the invention.

FIG. 40 is an illustration a method of revamping in situ electric power transmission lines of a preferred embodiment in accordance with one or more aspects and features of the invention.

FIG. 41 is an illustration of a revamping apparatus for performing the revamping method of FIG. 40.

FIG. 42 is an axial view along a power transmission line of the apparatus of FIG. 41.

FIG. 43 is an axial view along a cable conductor of a power transmission line of a portion of the revamping apparatus of FIG. 42, wherein a first compressor-roller mechanism of the apparatus is in a first position.

FIG. 44 is the axial view of FIG. 43, wherein the compressor-roller mechanism thereof is in a second position.

FIG. 45 is the axial view of FIG. 43, wherein the compressor-roller mechanism thereof is in a third position.

FIG. 46 is the axial view of FIG. 43, wherein the compressor-roller mechanism thereof is in a fourth position.

FIG. 47 is the axial view of FIG. 43, wherein the compressor-roller mechanism thereof is in a fifth position.

FIG. 48 is the axial view of FIG. 43, wherein the compressor-roller mechanism thereof is in a sixth position.

FIG. 49 is an axial view along a cable conductor of a power transmission line of a portion of the revamping apparatus of FIG. 42, wherein a second compressor-roller mechanism of the apparatus is in a first position.

FIG. 50 is the axial view of FIG. 49, wherein the compressor-roller mechanism thereof is in a second position.

FIG. 51 is the axial view of FIG. 49, wherein the compressor-roller mechanism thereof is in a third position.

FIG. 52 is the axial view of FIG. 49, wherein the compressor-roller mechanism thereof is in a fourth position.

FIG. 53 is the axial view of FIG. 49, wherein the compressor-roller mechanism thereof is in a fifth position.

FIG. 54 is the axial view of FIG. 49, wherein the compressor-roller mechanism thereof is in a sixth position.

FIG. 55 is an axial view along a cable conductor of a power transmission line of a portion of the revamping apparatus of FIG. 42, wherein a third compressor-roller mechanism of the apparatus is in a first position.

FIG. 56 is the axial view of FIG. 55, wherein the compressor-roller mechanism thereof is in a second position.

FIG. 57 is the axial view of FIG. 55, wherein the compressor-roller mechanism thereof is in a third position.

FIG. 58 is the axial view of FIG. 55, wherein the compressor-roller mechanism thereof is in a fourth position.

FIG. 59 is the axial view of FIG. 55, wherein the compressor-roller mechanism thereof is in a fifth position.

FIG. 60 is the axial view of FIG. 55, wherein the compressor-roller mechanism thereof is in a sixth position.

FIG. 61 is an axial view along a cable conductor of a power transmission line of a portion of the revamping apparatus of FIG. 42, wherein a fourth compressor-roller mechanism of the apparatus is in a first position.

FIG. 62 is the axial view of FIG. 61, wherein the compressor-roller mechanism thereof is in a second position.

FIG. 63 is the axial view of FIG. 61, wherein the compressor-roller mechanism thereof is in a third position.

FIG. 64 is the axial view of FIG. 61, wherein the compressor-roller mechanism thereof is in a fourth position.

FIG. 65 is the axial view of FIG. 61, wherein the compressor-roller mechanism thereof is in a fifth position.

FIG. 66 is the axial view of FIG. 61, wherein the compressor-roller mechanism thereof is in a sixth position.

FIG. 67 is an axial view similar to that of FIG. 53, wherein a compressor-roller mechanism is shown in greater detail to have rollers with surface contours configured to form a stack arrangement of surface indentations in the cable conductor.

FIG. 68 is an axial view similar to that of FIG. 54, wherein a compressor-roller mechanism is shown in greater detail forming top and bottom portions of a stack arrangement of surface indentations in a cable conductor.

FIG. 69 is an axial view similar to that of FIG. 53, wherein a compressor-roller mechanism is shown to have rollers with surface contours configured to form a mesh arrangement of surface indentations in the cable conductor.

FIG. 70 is an axial view similar to that of FIG. 54, wherein a compressor-roller mechanism is shown in greater detail forming top and bottom portions of a mesh arrangement of surface indentations in a cable conductor.

FIG. 71 is a schematic, side elevational view of the revamping apparatus of FIG. 41 when approaching an insulator (i.e., insulating support) of the electric power transmission system of FIG. 40, wherein the revamping apparatus is in a configuration for forming surface indentations in a cable conductor.

FIG. 72 is a side view similar to that of FIG. 71, wherein the revamping apparatus is in a configuration for retracting roller-compressor mechanisms into a housing of the apparatus.

FIG. 73 is a side view similar to that of FIG. 72, wherein the roller-compressor mechanisms are shown being retracted into the housing of the apparatus.

FIG. 74 is a side view similar to that of FIG. 73, wherein the roller-compressor mechanisms are shown being further retracted into the housing of the apparatus.

FIG. 75 is a side view similar to that of FIG. 74, wherein the roller-compressor mechanisms are shown fully retracted into the housing of the apparatus.

FIG. 76 is a side view similar to that of FIG. 75, wherein the revamping apparatus is shown advancing toward the insulator, and wherein a first, forwardmost suspension arm is shown in a first configuration.

FIG. 77 is an axial view similar to that of FIG. 75, wherein the first, forwardmost suspension arm is shown in the first configuration with a wheel thereof in engagement with the cable conductor.

FIG. 78 is a side view similar to that of FIG. 76, wherein the first, forwardmost suspension arm is shown in a second configuration.

FIG. 79 is an axial view similar to that of FIG. 77, wherein the first, forwardmost suspension arm is shown in the second configuration with the wheel thereof out of engagement with the cable conductor.

FIG. 80 is a side view similar to that of FIG. 78, wherein the first, forwardmost suspension arm is shown in a third configuration.

FIG. 81 is an axial view similar to that of FIG. 79, wherein the first, forwardmost suspension arm is shown in the third configuration is positioned for transitioning past the insulator, as shown in FIG. 80.

FIG. 82 is a side view similar to that of FIG. 80, wherein the first, forwardmost suspension arm is shown once again in the second configuration.

FIG. 83 is an axial view similar to that of FIG. 81, wherein the first, forwardmost suspension arm is shown again in the second configuration.

FIG. 84 is a side view similar to that of FIG. 82, wherein the first, forwardmost suspension arm is shown back in the first configuration, with the wheel thereof in engagement with the cable conductor.

FIG. 85 is an axial view similar to that of FIG. 83, wherein the first, forwardmost suspension arm is shown in the first configuration.

FIG. 86 is a schematic, side elevational view of the revamping apparatus of FIG. 85 as it progresses along the cable conductor, the first three suspension arms having transitioned past the insulator of the electric power transmission system of FIG. 40.

FIG. 87 is a schematic, side elevational view of the revamping apparatus of FIG. 86 as it progresses along the cable conductor, with the next three suspension arms of the revamping apparatus each being in the first configuration in their approach to the insulator of the electric power transmission system of FIG. 40.

FIG. 88 is a side view similar to that of FIG. 87, wherein the first, forwardmost suspension arm of the next set is shown in the second configuration.

FIG. 89 is a side view similar to that of FIG. 88, wherein the first, forwardmost suspension arm of the next set is shown in the third configuration for transitioning past the insulator, as illustrated therein.

FIG. 90 is a side view similar to that of FIG. 89, wherein the first, forwardmost suspension arm of the next set is shown again in the second configuration.

FIG. 91 is a side view similar to that of FIG. 90, wherein the first, forwardmost suspension arm of the next set is shown back in the first configuration.

FIG. 92 is a schematic, side elevational view of the revamping apparatus of FIG. 85 after transitioning along the cable conductor past the insulator of the electric power transmission system of FIG. 40.

FIG. 93 is a schematic, side elevational view of the revamping apparatus of FIG. 41 after transitioning past the insulator of the electric power transmission system of FIG. 40, wherein the revamping apparatus is ready to transition to a configuration for forming surface indentations in the cable conductor.

FIG. 94 is another side view similar to that of FIG. 93, wherein the compressor-roller mechanisms are shown in their fully retracted positions within the housing of the revamping apparatus following transitioning of the revamping apparatus past the insulator.

FIG. 95 is a side view similar to that of FIG. 94, wherein the roller-compressor mechanisms are seen being extended from the housing of the revamping apparatus.

FIG. 96 is a side view similar to that of FIG. 95, wherein the roller-compressor mechanisms are seen being further extended from the housing of the revamping apparatus.

FIG. 97 is a side view similar to that of FIG. 96, wherein the roller-compressor mechanisms are fully extended from the housing of the revamping apparatus and are back in a position corresponding to that shown in FIG. 72.

FIG. 98 is a side view similar to that of FIG. 97, wherein the revamping apparatus is shown once again in the configuration for forming surface indentations in a cable conductor, the configuration corresponding to that of FIG. 71.

FIG. 99 is an illustration of another method of revamping electric power transmission lines of a preferred embodiment in accordance with one or more aspects and features of the invention.

FIG. 100 is an illustration of another method of revamping electric power transmission lines of a preferred embodiment in accordance with one or more aspects and features of the invention.

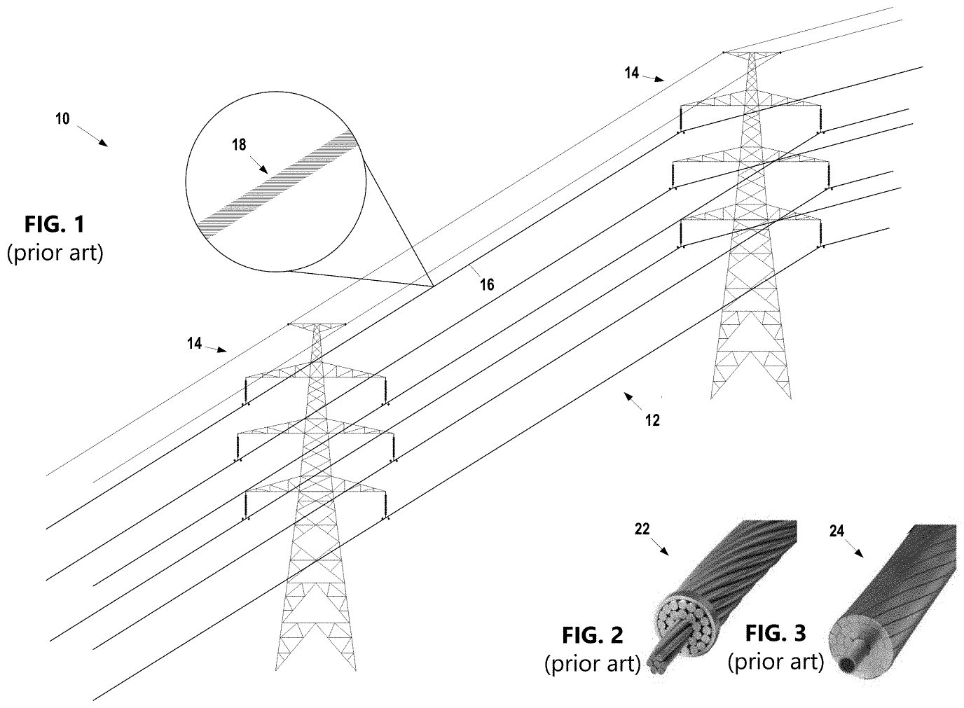

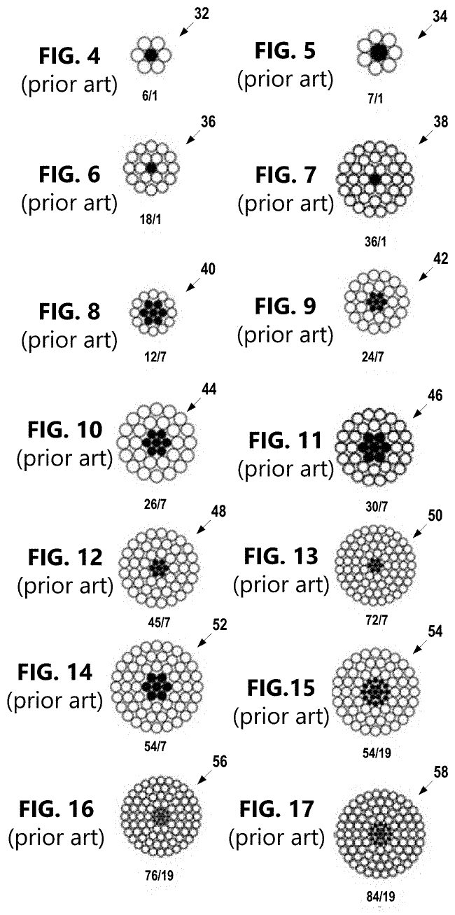

### DETAILED DESCRIPTION

As a preliminary matter, it will readily be understood by one having ordinary skill in the relevant art (“Ordinary Artisan”) that the invention has broad utility and application. Furthermore, any embodiment discussed and identified as being “preferred” is considered to be part of a best mode contemplated for carrying out the invention. Other embodiments also may be discussed for additional illustrative purposes in providing a full and enabling disclosure of the invention. Furthermore, an embodiment of the invention may incorporate only one or a plurality of the aspects of the invention disclosed herein; only one or a plurality of the features disclosed herein; or combination thereof. As such, many embodiments are implicitly disclosed herein and fall within the scope of what is regarded as the invention.

Accordingly, while the invention is described herein in detail in relation to one or more embodiments, it is to be understood that this disclosure is illustrative and exemplary of the invention and is made merely for the purposes of providing a full and enabling disclosure of the invention. The detailed disclosure herein of one or more embodiments is not intended, nor is to be construed, to limit the scope of patent protection afforded the invention in any claim of a patent issuing here from, which scope is to be defined by the claims and the equivalents thereof. It is not intended that the scope of patent protection afforded the invention be defined by reading into any claim a limitation found herein that does not explicitly appear in the claim itself

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the invention. Accordingly, it is intended that the scope of patent protection afforded the invention be defined by the issued claim(s) rather than the description set forth herein.

Additionally, it is important to note that each term used herein refers to that which the Ordinary Artisan would understand such term to mean based on the contextual use of such term herein. To the extent that the meaning of a term used herein—as understood by the Ordinary Artisan based on the contextual use of such term—differs in any way from any particular dictionary definition of such term, it is intended that the meaning of the term as understood by the Ordinary Artisan should prevail.

With regard solely to construction of any claim with respect to the United States, no claim element is to be interpreted under 35 U.S.C. 112(f) unless the explicit phrase “means for” or “step for” is actually used in such claim element, whereupon this statutory provision is intended to and should apply in the interpretation of such claim element. With regard to any method claim including a condition precedent step, such method requires the condition precedent to be met and the step to be performed at least once but not necessarily every time during performance of the claimed method.

Furthermore, it is important to note that, as used herein, “comprising” is open-ended insofar as that which follows such term is not exclusive. Additionally, “a” and “an” each generally denotes “at least one” but does not exclude a plurality unless the contextual use dictates otherwise. Thus, reference to “a picnic basket having an apple” is the same as “a picnic basket comprising an apple” and “a picnic basket including an apple”, each of which identically describes “a picnic basket having at least one apple” as well as “a picnic basket having apples”; the picnic basket further may contain one or more other items beside an apple. In contrast, reference to “a picnic basket having a single apple” describes “a picnic basket having only one apple”; the picnic basket further may contain one or more other items beside an apple. In contrast, “a picnic basket consisting of an apple” has only a single item contained therein, i.e., one apple; the picnic basket contains no other item.

When used herein to join a list of items, “or” denotes “at least one of the items” but does not exclude a plurality of items of the list. Thus, reference to “a picnic basket having cheese or crackers” describes “a picnic basket having cheese without crackers”, “a picnic basket having crackers without cheese”, and “a picnic basket having both cheese and crackers”; the picnic basket further may contain one or more other items beside cheese and crackers.

When used herein to join a list of items, “and” denotes “all of the items of the list”. Thus, reference to “a picnic basket having cheese and crackers” describes “a picnic basket having cheese, wherein the picnic basket further has crackers”, as well as describes “a picnic basket having crackers, wherein the picnic basket further has cheese”; the picnic basket further may contain one or more other items beside cheese and crackers.

The phrase “at least one” followed by a list of items joined by “and” denotes an item of the list but does not require every item of the list. Thus, “at least one of an apple and an orange” encompasses the following mutually exclusive scenarios: there is an apple but no orange; there is an orange but no apple; and there is both an apple and an orange. In these scenarios if there is an apple, there may be more than one apple, and if there is an orange, there may be more than one orange. Moreover, the phrase “one or more” followed by a list of items joined by “and” is the equivalent of “at least one” followed by the list of items joined by “and”.

Referring now to the drawings, one or more preferred embodiments of the invention are next described. The following description of one or more preferred embodiments is merely exemplary in nature and is in no way intended to limit the invention, its implementations, or uses.

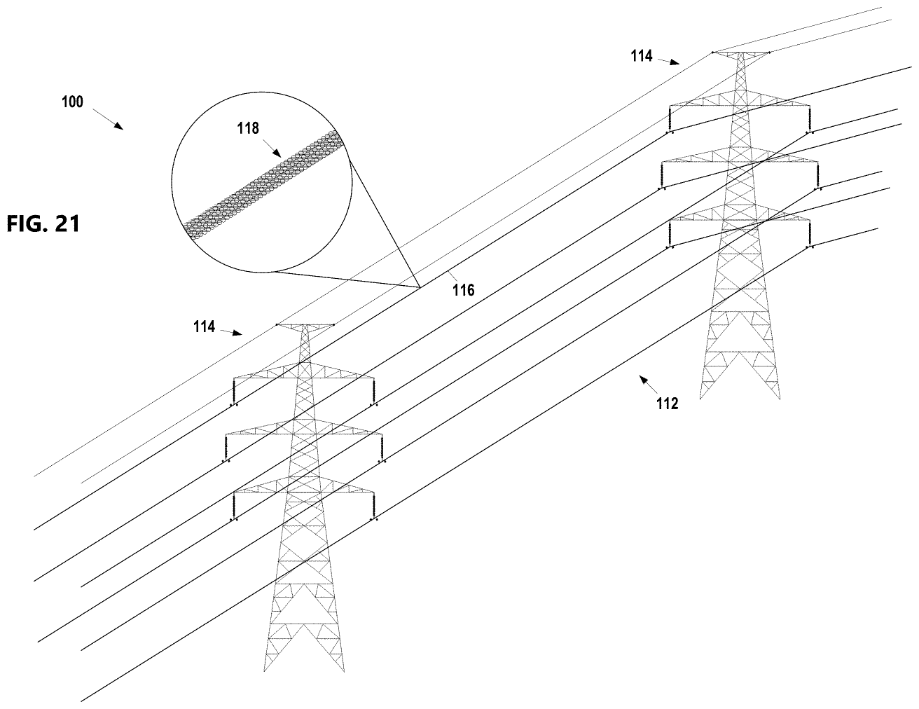

Turning now to FIG. 21, electric power transmission lines 112 extending between electric power transmission towers 114 in a preferred embodiment of an electric power transmission system 100 in accordance with one or more aspects and features of the invention is illustrated.

In such system 100, an electrical cable conductor 116 comprises a plurality of conductive strands 118 wound around a core and defining an outermost, exposed surface of the cable conductor 116. These outer strands preferably comprise aluminum (including aluminum alloys such as aluminum zirconium). The core preferably is conventional and may comprise, for example, strands of aluminum or aluminum alloy; aluminum-clad steel; or a composite core including, for example, carbon and glass fibers.

In accordance with aspects and features of the present invention, the outermost, exposed surface of the cable conductor 116 has a plurality of surface indentations formed therein. As seen in the close-up view of FIG. 21, the surface indentations of the cable conductor 116 comprise roundish dents or dimples that have been formed in the outermost exposed surface of the cable conductor 116.

As used herein “dimpled surface” means a surface in which at least 75% of the area of the surface comprises surface indentations, whether such indentations are round dents, dimples, or other indentation shape. As illustrated in FIG. 21, the surface indentations are formed such that the outermost surface of the cable conductor consists of a dimpled surface and, more particularly, consists of dimpled surfaces of the outermost strands.

As discussed in greater detail below, the surface indentations shown in FIG. 21 are formed in a repeating arrangement of surface indentations. Specifically, surface indentations are arranged along a circumferential axis in a cylindrical coordinate system, i.e., in the circumferential direction, around a longitudinal axis of the cable's core, with such a circumferential arrangement being located immediately adjacent to an immediately preceding and an immediately following circumferential arrangement of surface indentations. Each surface indentation in FIG. 21 preferably has a round or oval periphery, and more preferably a circular periphery.

Furthermore, in this arrangement shown in FIG. 21, each surface indentation of a circumferential arrangement is longitudinally aligned with both a surface indentation in the immediately preceding circumferential arrangement of surface indentations and a surface arrangement in the immediately following circumferential arrangement of surface indentations. Such disposition of the surface indentations as seen in FIG. 21 is referred to herein as a “stack”.

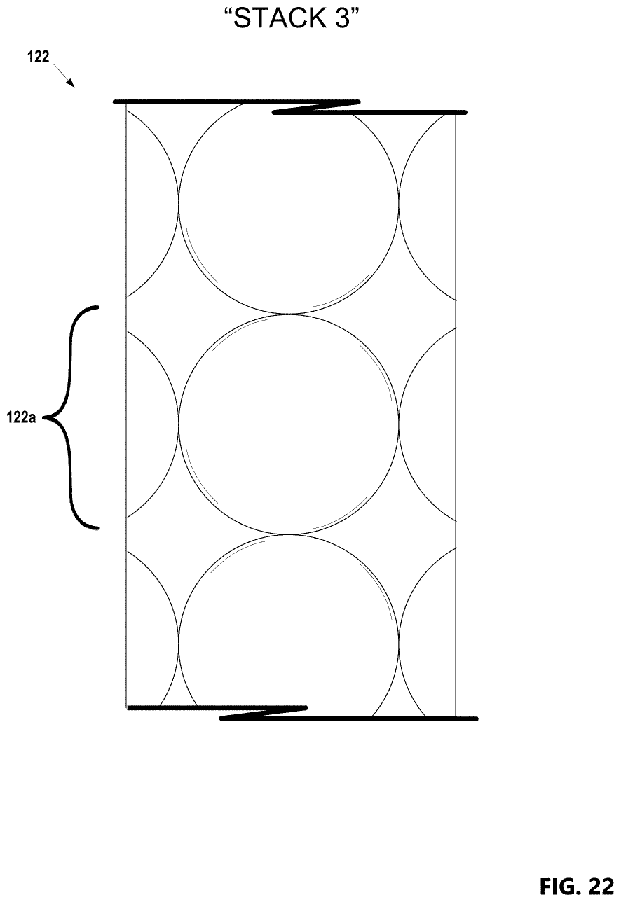

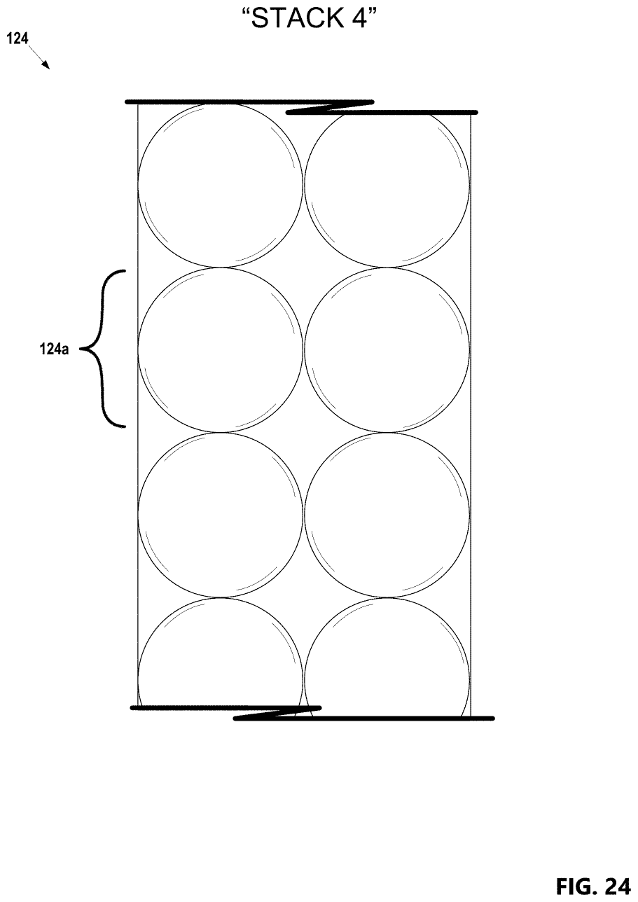

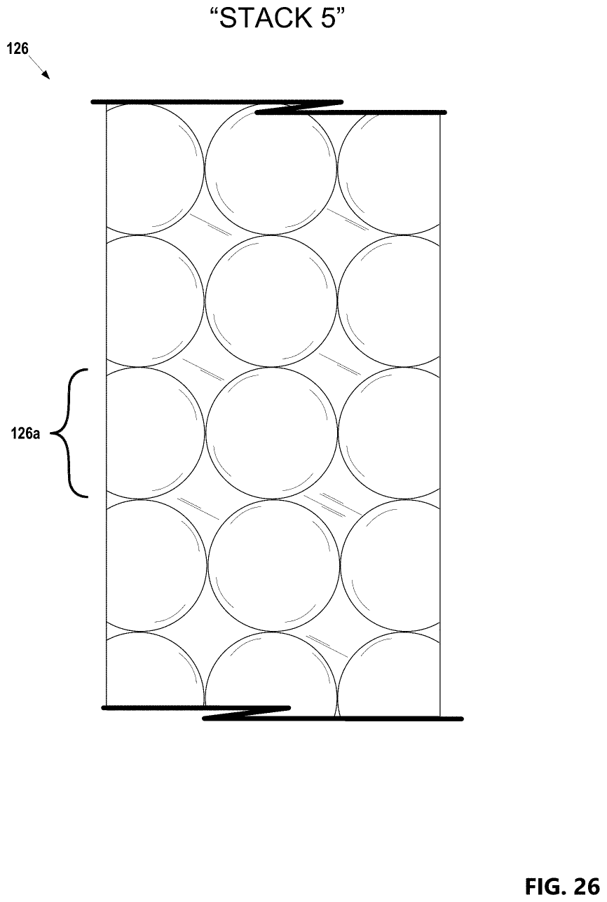

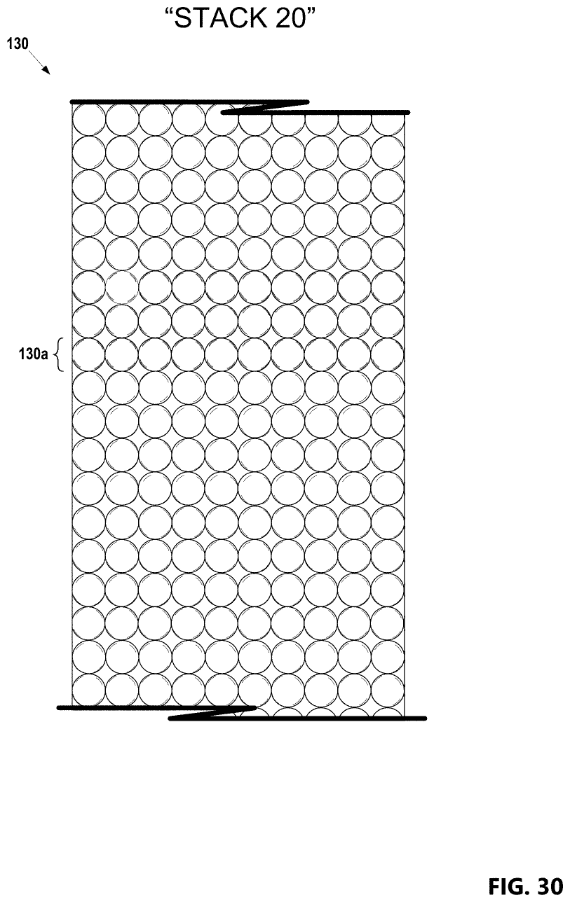

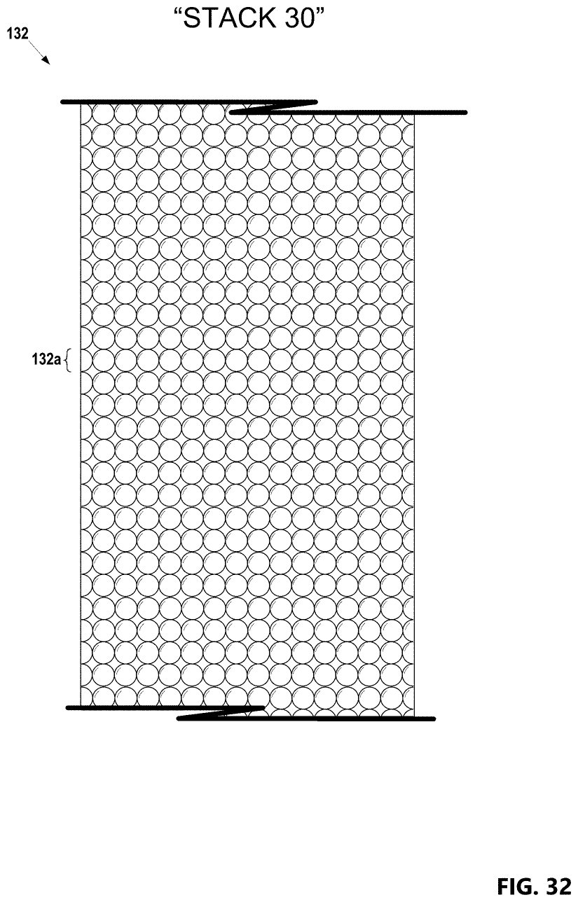

While FIG. 21 illustrates a stack pattern in the outermost, exposed surface of the cable conductor 116, such a stack pattern also can be formed in each of the strands forming the outermost, exposed surface of the cable conductor. In this regard, FIG. 22 is a top plan view of a portion of a strand 122 comprising a stack of surface indentations, wherein each circumferential arrangement 122a has three surface indentations (only half of which are seen in the top plan view); FIG. 24 is a top plan view of a portion of a strand 124 comprising a stack of circumferential arrangements of surface indentations, wherein each circumferential arrangement 124a has four surface indentations (only half of which are seen in the top plan view); FIG. 26 is a top plan view of a portion of a strand 126 comprising a stack of circumferential arrangements of surface indentations, wherein each circumferential arrangement 126a has five surface indentations (only half of which are seen in the top plan view); FIG. 28 is a top plan view of a portion of a strand 128 comprising a stack of circumferential arrangements of surface indentations, wherein each circumferential arrangement 128a has ten surface indentations (only half of which are seen in the top plan view); FIG. 30 is a top plan view of a portion of a strand 130 comprising a stack of circumferential arrangements of surface indentations, wherein each circumferential arrangement 130a has twenty surface indentations(only half of which are seen in the top plan view); and FIG. 32 is a top plan view of a portion of a strand 132 comprising a stack of circumferential arrangements of surface indentations, wherein each circumferential arrangement 132a has thirty surface indentations (only half of which are seen in the top plan view).

In contrast, each surface indentation of a circumferential arrangement alternatively may be longitudinally offset both with a surface indentation in the immediately preceding circumferential arrangement of surface indentations and with a surface arrangement in the immediately following circumferential arrangement of surface indentations. Such a disposition of the surface indentations is referred to herein as a “mesh”. Additionally, in a mesh disposition, a larger number of circumferential arrangements can be located along a given longitudinal length of the strand or cable conductor than in a stack.

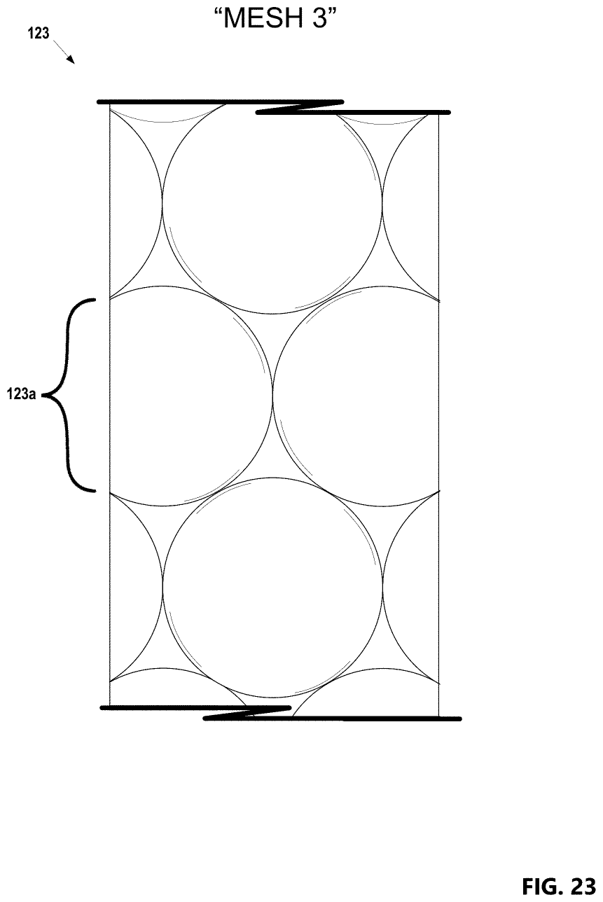

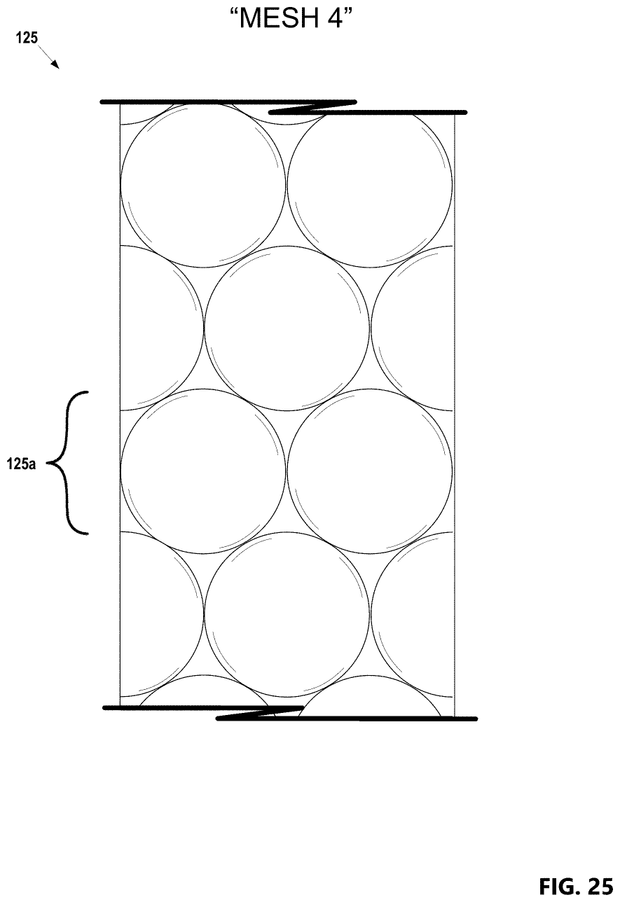

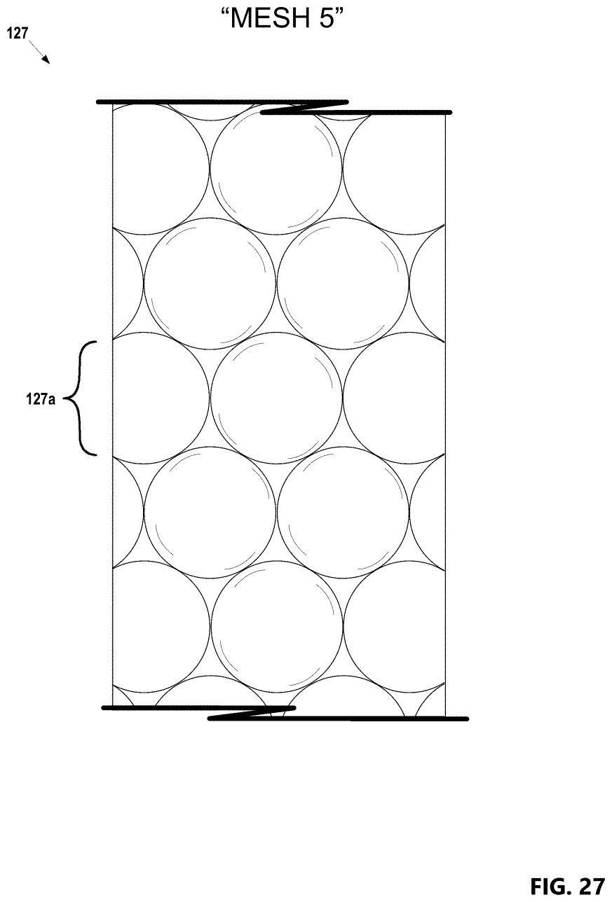

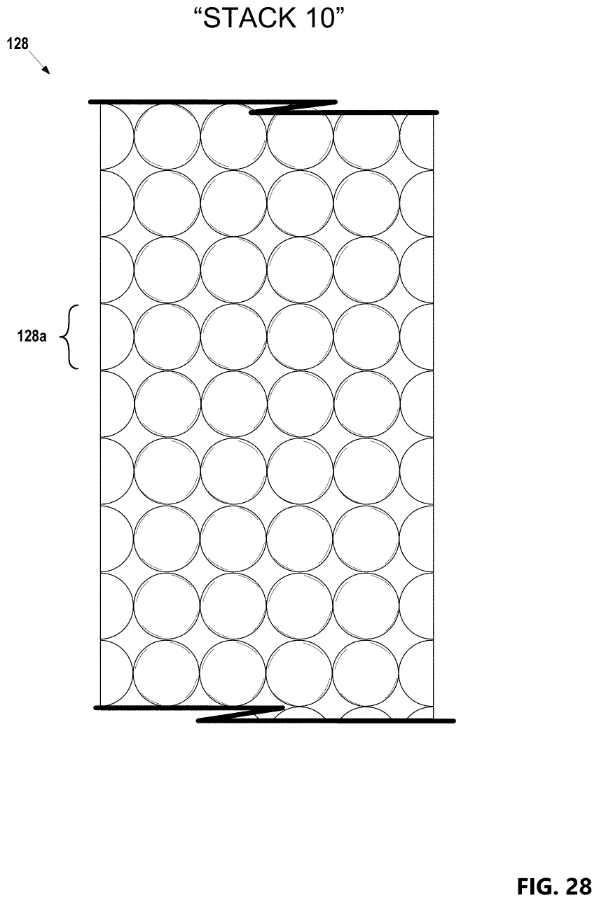

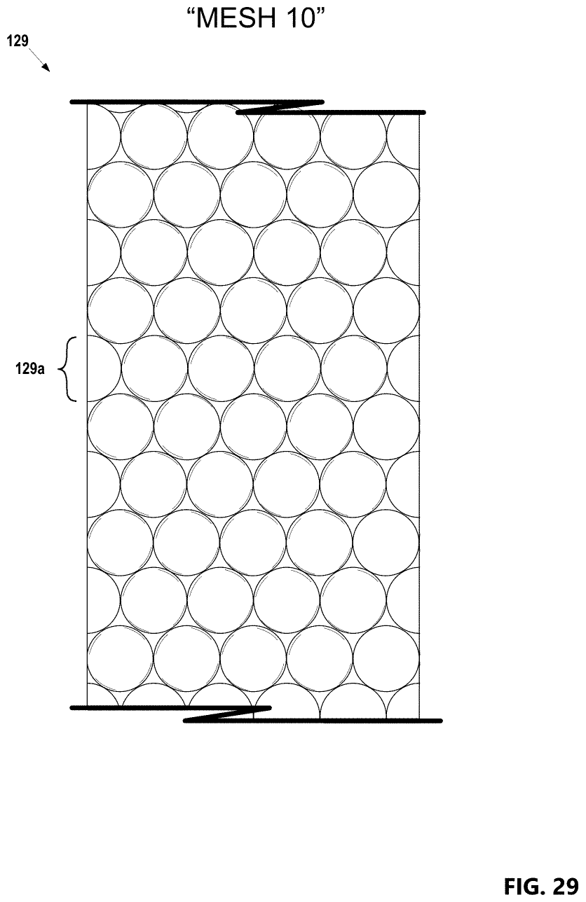

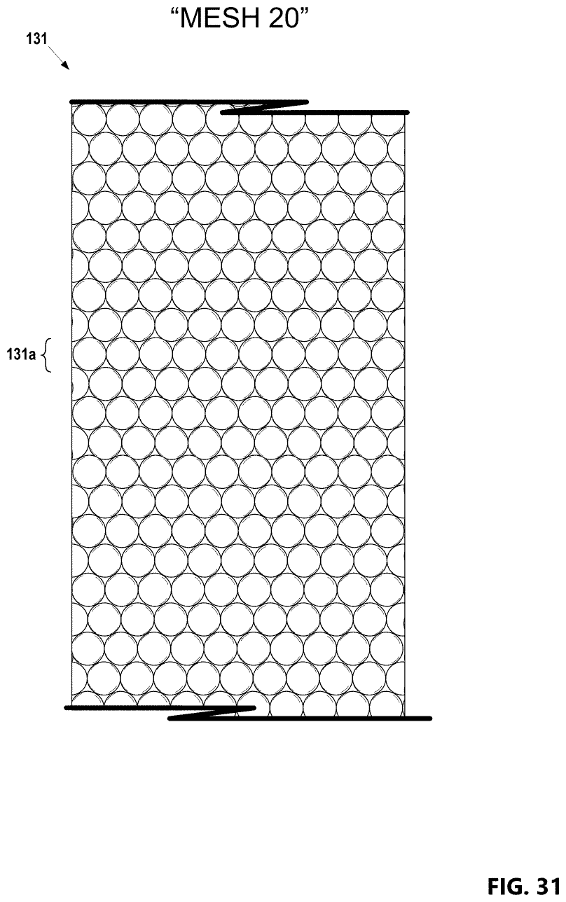

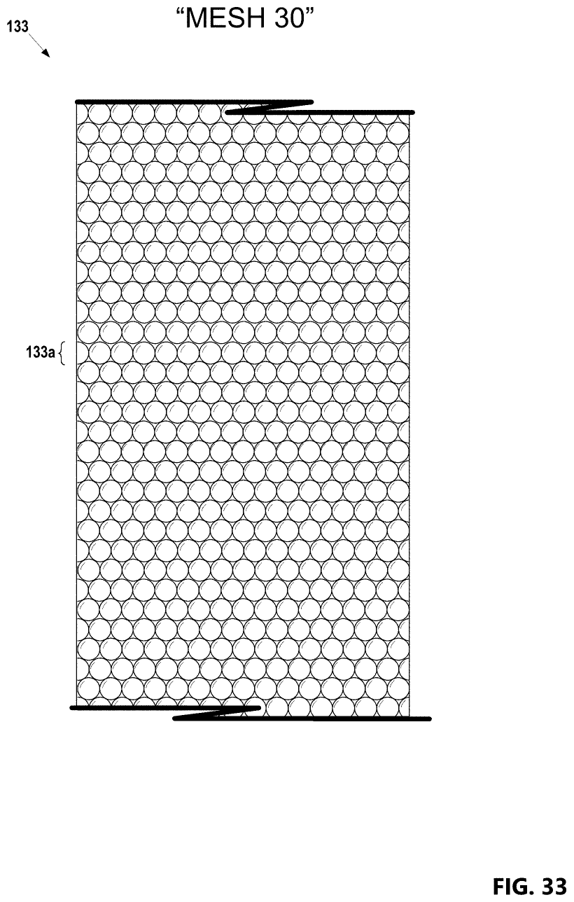

In this regard, FIG. 23 is a top plan view of a portion of a strand 123 comprising a mesh of circumferential arrangements, wherein each circumferential arrangement 123a has three surface indentations (only half of which are seen in the top plan view); FIG. 25 is a top plan view of a portion of a strand 125 comprising a mesh of circumferential arrangements of surface indentations, wherein each circumferential arrangement 125a has four surface indentations (only half of which are seen in the top plan view); FIG. 27 is a top plan view of a portion of a strand 127 comprising a mesh of circumferential arrangements of surface indentations, wherein each circumferential arrangement 127a has five surface indentations (only half of which are seen in the top plan view); FIG. 29 is a top plan view of a portion of a strand 129 comprising a mesh of circumferential arrangements of surface indentations, wherein each circumferential arrangement 129a has ten surface indentations (only half of which are seen in the top plan view); FIG. 31 is a top plan view of a portion of a strand 131 comprising a mesh of circumferential arrangements of surface indentations, wherein each circumferential arrangement 131a has twenty surface indentations (only half of which are seen in the top plan view); and FIG. 33 is a top plan view of a portion of a strand 133 comprising a mesh of circumferential arrangements of surface indentations, wherein each circumferential arrangement 133a has thirty surface indentations (only half of which are seen in the top plan view).

In view of the foregoing, it will be appreciated that in the stacks of FIGS. 22, 24, 26, 28, 30, and 32, a periphery of a given surface indentation is located adjacent a periphery of each of two other surface indentations immediately adjacent to it in its circumferential arrangement, and is located adjacent a periphery of a first surface indentation of the immediately preceding circumferential arrangement and the periphery of a second surface indentation of the immediately following circumferential arrangement with which first and second surfaces indentations the given surface indentation is aligned in the longitudinal direction.

Additionally, it view of the foregoing, it will be appreciated that in the mesh of FIGS. 23, 25, 27, 29, 31, and 33, a periphery of a given surface indentation is located adjacent a periphery of each of two other surface indentations immediately adjacent to it in its circumferential arrangement, and is located adjacent a periphery of each of a first and second surface indentations of the immediately preceding circumferential arrangement, and a periphery of each of first and second surface indentations of the immediately following circumferential arrangement.

With respect to oval surface indentations such as those comprising dimples for instance, it is believed that a ratio of the diameter of the dimple to the depth of the dimple is an important variable in the percentage increase in thermal rating of a dimpled cable conductor versus a smooth cable conductor. Similarly, the packing density of surface indentations also is believed to be an important factor and, as will be appreciated from the foregoing illustration of various stack and mesh patterns of dimples, the higher the number of dimples per circumferential arrangement, the higher the percentage increase in thermal rating of a cable conductor with a dimpled surface. Moreover, there will also be a higher increase in thermal rating if the circumferential arrangements of dimples are offset from each other in a mesh pattern rather than in a stack pattern.

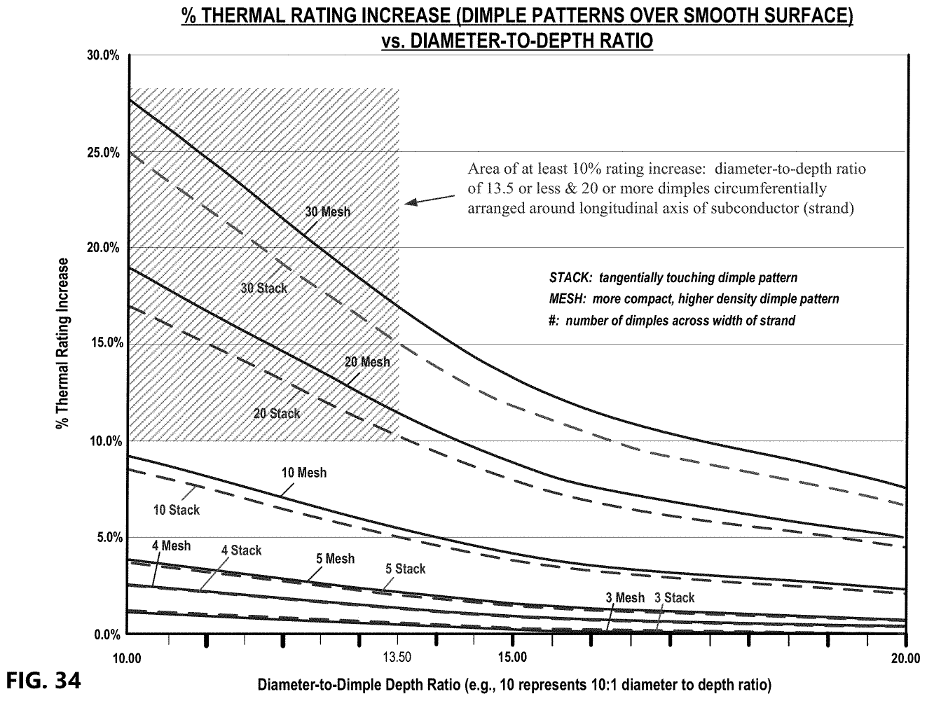

To illustrate this, FIG. 34 charts a calculated percent thermal rating increase versus a calculated diameter-to-depth ratio. The outer strands of the cable conductors of the chart correspond to the strands of FIGS. 22-33.

Preferably, a cable conductor in accordance with commercially preferred embodiments of the invention will have at least a 10% thermal rating increase. Such a cable conductor in accordance with commercially preferred embodiments will have a diameter-to-depth ratio of 13.5 or less and twenty or more dimples circumferentially arranged around the longitudinal axis of the cable conductor. The area highlighted in the chart reflects such commercially preferred cable conductors.

With regard to the calculations performed in creating the chart of FIG. 34, the thermal rating is expressed in amperes and is the maximum continuous current carrying capacity of a conductor at a given operating temperature, and under fixed, static environmental and weather conditions. Normally, and most commonly and typically, the IEEE-738 standard assumes a wind speed across the surfaces of the cable conductor of 2 ft./second at 90 degrees, with full incident sunlight, a clear atmosphere, and an ambient air temperature based on a maximum ambient temperature for a region and time of year (for which 104° F. (40° C.) is often used as an assumption).

There are a number of methods of making cable conductors of preferred embodiments in accordance with one or more aspects and features of the invention. Such methods include manufacturing methods as well as revamping methods for both cable conductors in situ and cable conductors that are “in stock” and on reels prior to being deployed in power transmission systems.

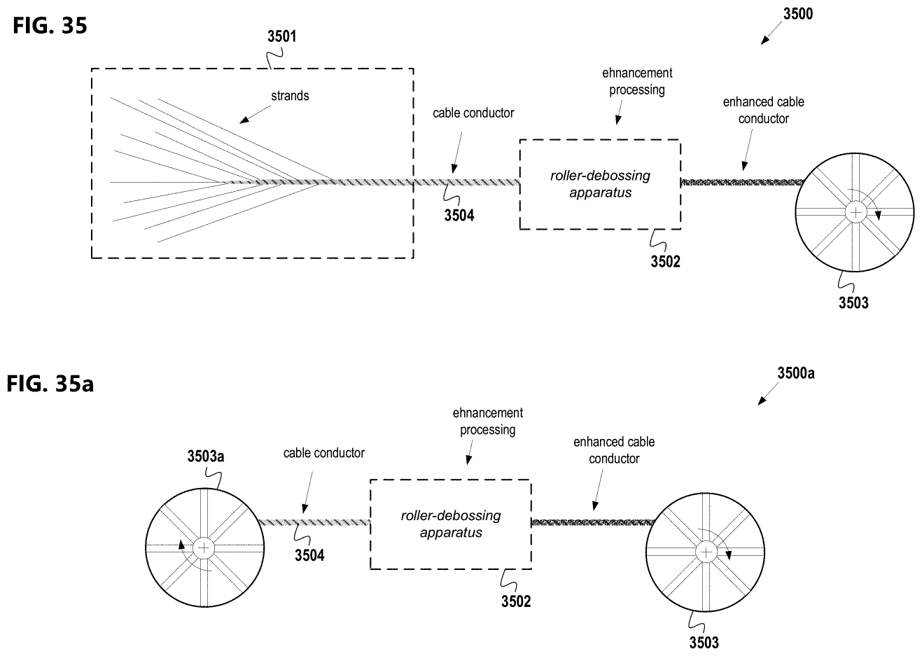

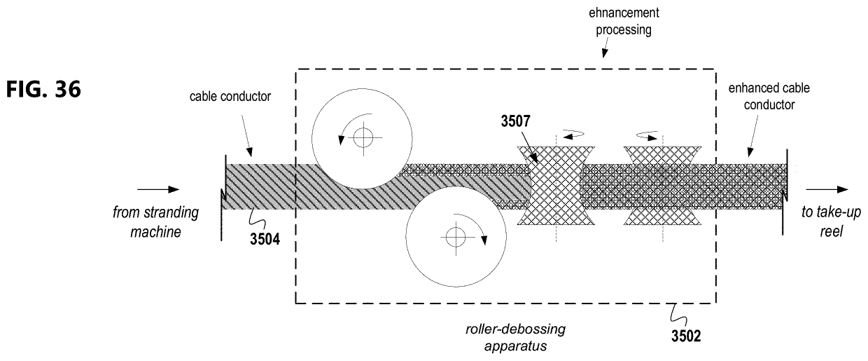

For example, FIG. 35 illustrates one method 350 of making a cable conductor of a preferred embodiment; and FIG. 36 illustrates the enhancement processing of the method 3500 that is performed. As used herein, “enhancement” is intended to mean the increase in the thermal rating and ampacity and decrease in the operating temperature of a cable conductor without altering emissivity, which is believed to be accomplished by forming the surface indentations in accordance with one or more aspects and features of the present invention.

In method 3500, a plurality of outer strands of aluminum or aluminum alloy (or other conductive material) are wrapped or wound around a core, which may comprise one or more strands itself. This step 3501 is performed at a winding machine. The resulting cable conductor coming from the wining machine is complete in so far as the cable conductor is functional for use in overhead electric power transmission systems; however, in accordance with preferred embodiments of the invention, the cable conductor then is improved through an enhancement processing step 3502 prior to being wound onto a take-up reel at step 3503. In the method 3500, the enhancement processing comprising use of a roller-debossing mechanism to form surface indentations on the outermost exposed conductive surface of the cable conductor.

FIG. 35a is an illustration of a method 3500a that is similar to method 3500 of FIG. 35. Rather than manufacturing a cable conductor by way of method 3500, cable conductor 3504 that has already been manufactured and taken up on a reel—but that has not yet been deployed and is “in stock”—is revamped using the roller-debossing apparatus 3502 of method 3500a. Indeed, as will be appreciated by the Ordinary Artisan, many manufacturing methods disclosed herein are equally applicable to use in revamping an already manufactured conductor.

FIG. 36 illustrates schematically the enhancement processing step 3502 of FIG. 35. This step 3502 is performed using a plurality of rollers, each of which has an embossed surface 3507 of sufficient hardness such that tensioned rolling of an exposed, outermost conductive surface of the cable conductor debosses said surface forming surface indentations therein. Four such rollers are illustrated in FIG. 36 for illustration purposes, and more can be utilized if needed in order to obtain well-formed surface indentations. As shown, each roller engages only a portion of the surface, and a plurality of rollers will be necessary in order to cover all or a substantial portion of the outer exposed conductive surface of the cable conductor.

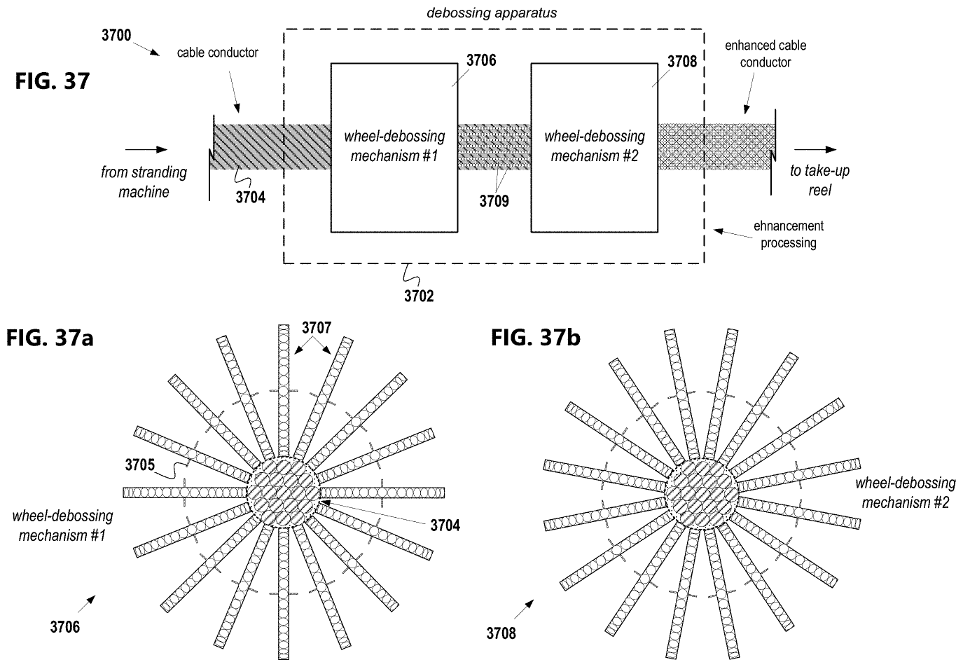

FIG. 37 illustrates alternative methods 3700 of making and revamping cable conductors of preferred embodiments using a debossing apparatus 3702, and FIGS. 37a and 37b each illustrates a wheel-debossing mechanism used in the enhancement processing performed by the debossing apparatus 3702 of the methods 3700. In particular, FIG. 37a illustrates schematically a first wheel-debossing mechanism 3706 that comprises a number of driven wheels 3707 that rotate about respective axes 3705 and that have embossed surfaces of sufficient hardness such that tensioned rolling thereof on exposed, outermost conductive surfaces of the cable conductor 3704 debosses said surfaces forming the desired surface indentations therein. The second wheel-debossing mechanism 3708 of FIG. 37b is the same as the first wheel-debossing mechanism 3706 but is orientated to engage and deboss areas 3709 of the cable conductor not debossed by the first wheel-debossing mechanism 3706.

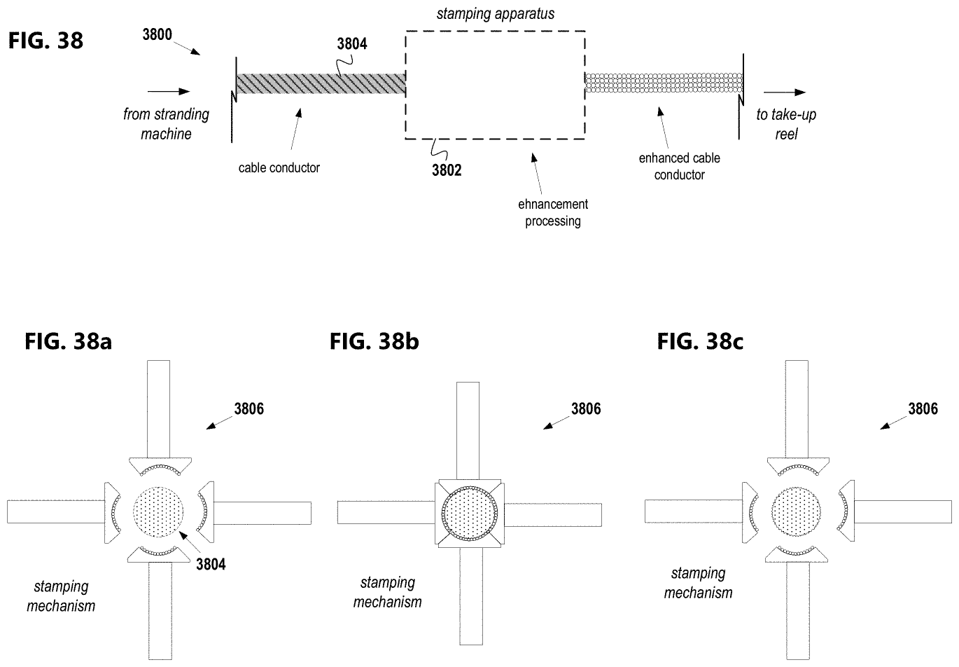

FIG. 38 illustrates alternative methods 3800 of making and revamping cable conductors of preferred embodiments, wherein the enhancement processing utilizes a stamping apparatus 3802 having a stamping mechanism 3806, which is illustrated in FIGS. 38a, 38b, and 38c. In particular, the stamping mechanism 3806 is illustrated in a first position for acting upon the cable conductor 3804 in FIG. 38a. The stamping mechanism comprises four stamping arms each having an embossed surface for impact with the exposed, outermost conductive surface of the cable conductor 3804. The embossed surfaces of the four stamping arms preferably encircle the cable conductor for forming the surface indentations, as seen in FIG. 38b during the actually stamping process. FIG. 38c illustrates the cable conductor after the stamping of FIG. 38b, in which the four arms are withdrawn from their stamping engagement with the cable conductor.

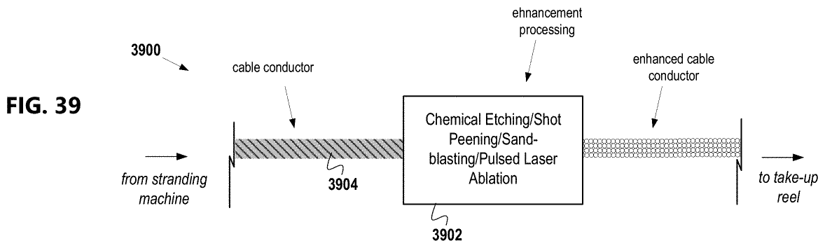

FIG. 39 illustrates yet alternative methods 3900 of making and revamping a cable conductor of preferred embodiments, wherein the enhancement processing 3902 comprises chemical etching, shot peening, sandblasting, or pulse laser ablation for forming the surface indentations on the outermost exposed conductive surfaces of the cable conductor.

While the foregoing methods of making and/or revamping cable conductors of preferred embodiments have been described with respect to cable conductors, it will be appreciated that such methods can be applied to strands that subsequently can be wound about a core as the outermost strands of the cable conductor thus forming the outermost exposed surface of the cable conductor.

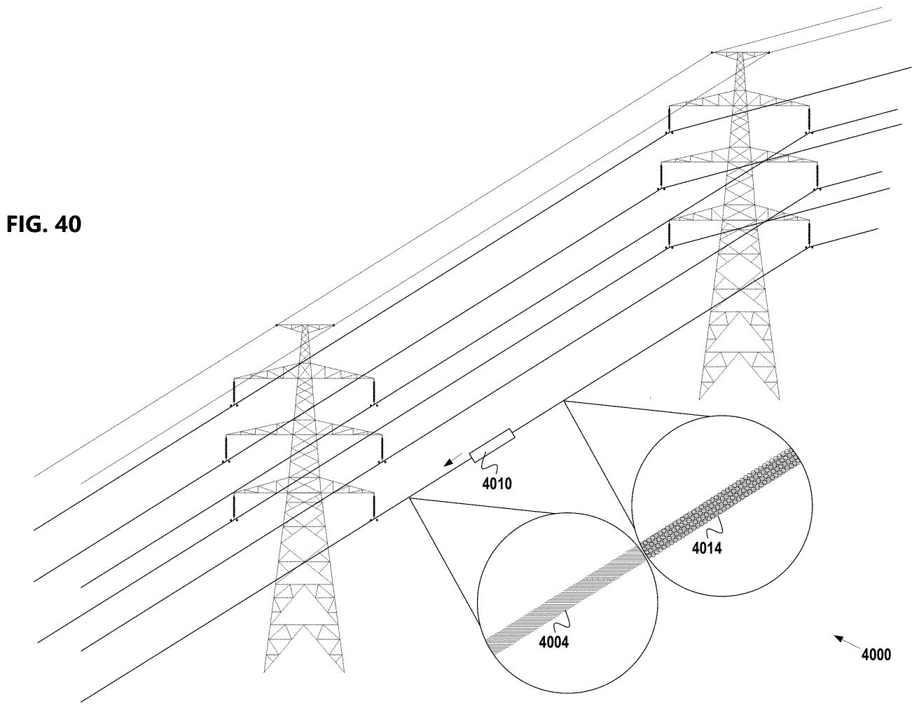

Additionally, while many of the foregoing methods of making and revamping cable conductors of preferred methods have been described with reference to manufacturing of the cable conductors for later deployment and use in the field, it will be appreciated that preferred cable conductors can be made by revamping conventional cable conductors already in use, i.e., in situ, without requiring that the cable conductors be taken down to be revamped. In this respect, FIG. 40 is an illustration a method 4000 of revamping electric power transmission lines of a preferred embodiment in accordance with one or more aspects and features of the invention. The method utilizes a revamping apparatus 4010 which forms the desired surface indentations in a conventional cable conductor 4004 so as to produce the enhanced cable conductor 4014 of the invention, which enhanced conductor 4014 has a greater surface area than that of the conventional cable conductor 4004 due to the surface indentations that are formed.

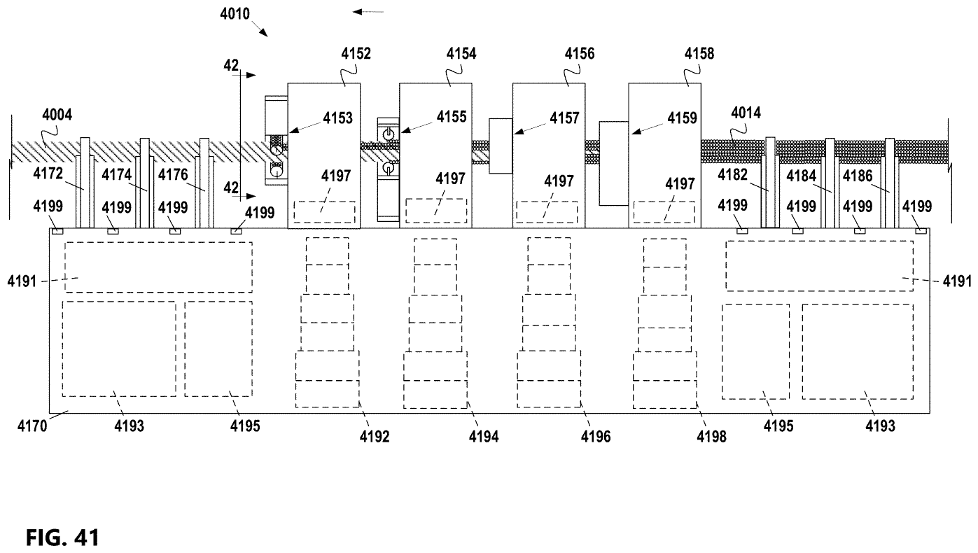

The revamping apparatus 4010 for performing the revamping method 4000 illustrated in FIG. 40 is perhaps best seen in FIG. 41. The apparatus 4010 comprises a first compressor-roller mechanism 4152 having a pair of compressor-rollers mounted on a rotatable arm 4153; a second compressor-roller mechanism 4154 having a pair of compressor-rollers mounted on a rotatable arm 4155; a third compressor-roller mechanism 4156 having a pair of compressor-rollers mounted on a rotatable arm 4157; and a fourth compressor-roller mechanism 4158 having a pair of compressor-rollers mounted on a rotatable arm 4159. Each said compressor-roller mechanism preferably comprises circuitry and a power source (generally indicated at 4162,4164,4166,4168) for controlling respective operation of the compressor-rollers and rotation of the arm.

The revamping apparatus 4010 preferably is suspended from the power line by a first set of suspension arms 4172,4174,4176 and a second set of suspension arms 4182,4184,4186. Each of the first and second sets of suspension arms is located on a respective opposite side of the compressor-roller mechanisms 4152,4154,4156,4258. The suspension arms include wheels by which the revamping apparatus transitions along the power line.

A housing 4170 of the revamping apparatus 4010 preferably is located below the power line when the apparatus is suspended by the suspension arms. The housing 4170 preferably is by far the heaviest portion of the apparatus and serves to stabilize the apparatus in its suspension below the power line. The housing includes contained therein lift mechanisms 4192,4194,4196,4198 (shown in phantom) by which each of the compressor-roller mechanisms is raised or extended above a top of the housing and by which each of the compressor-roller mechanisms is retracted or lowered into the housing. One or more controllers 4191, power sources 4193 (including for example rechargeable batteries), and drive mechanism 4195 are provided within the housing for controlling advancement of the apparatus along the power line and overall operation of the compressor-roller mechanisms Each compressor-roller mechanism also may comprise a respective controller, power source, and/or drive mechanism, generally indicated at 4197. Sensors 4199 also preferably are provided for sensing and/or determining the position of the apparatus along the power line and proximity to insulators or other obstacles for traversing thereof by the apparatus.

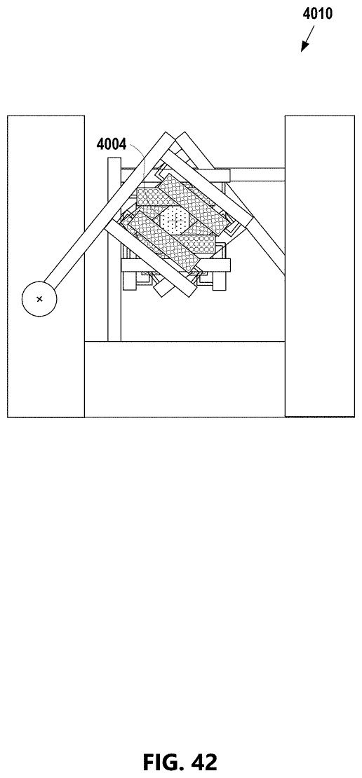

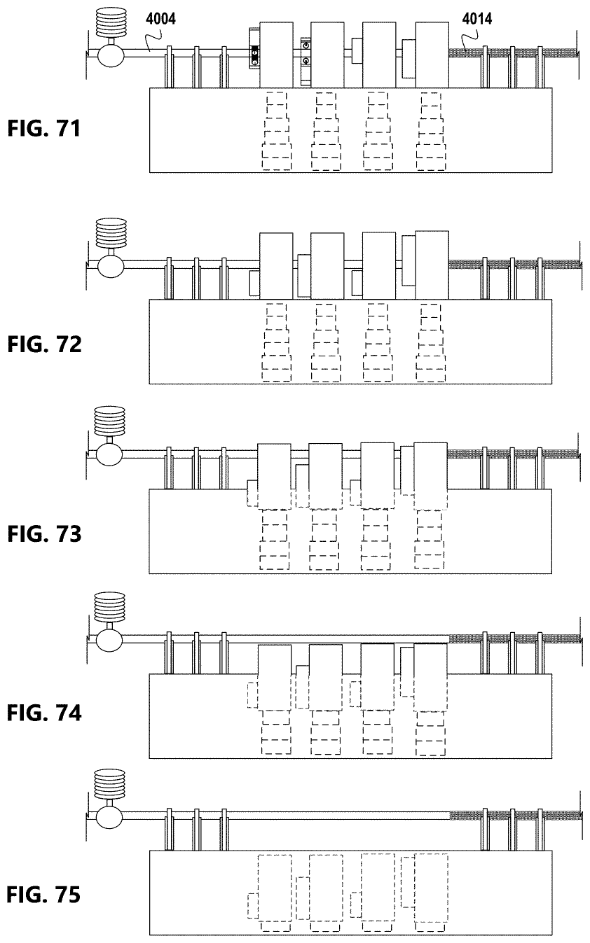

The revamping apparatus 4010 travels along each power line and traverses each insulator (i.e., insulating support), as discussed now with reference to FIGS. 42-98. In particular, FIGS. 42-70 illustrate the revamping process that is performed by the revamping apparatus 4010, and FIGS. 71-98 illustrate the traversing of an insulator (i.e., insulating support of the power lines) by the revamping apparatus 4010 when traveling along the power lines for revamping the cable conductors.

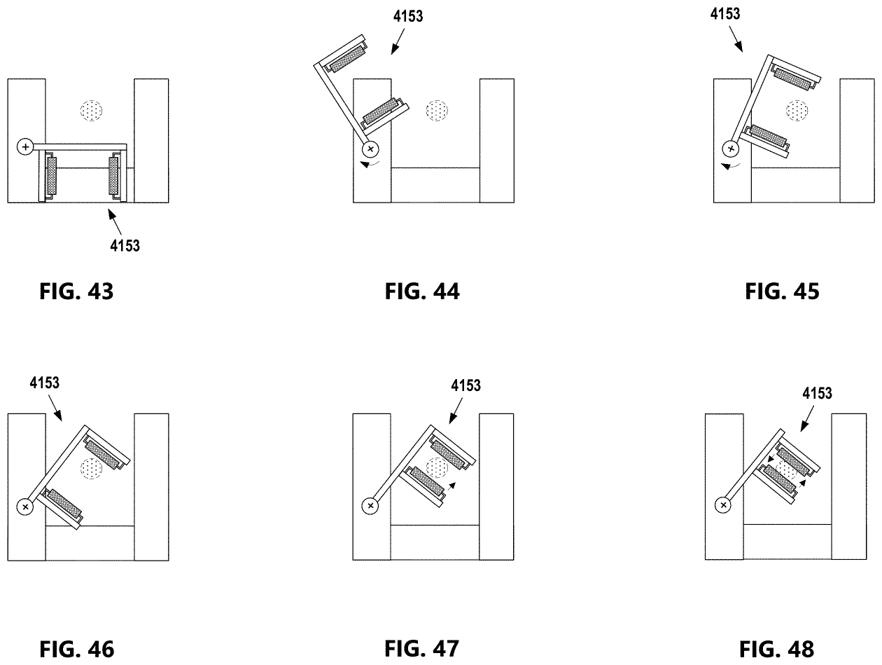

With reference to FIGS. 42-70, FIG. 42 is an axial view of the revamping apparatus 4010 taken along line 42-42 of FIG. 41, which view lies along a longitudinal axis of the cable conductor 4004; FIG. 43 is an axial view along the cable conductor 4004 of a portion of the revamping apparatus 4010, wherein the arm of the first compressor-roller mechanism 4153 is in a first position; FIG. 44 is the axial view of FIG. 43, wherein the arm of the first compressor-roller mechanism 4153 is in a second position; FIG. 45 is the axial view of FIG. 43, wherein the arm of the first compressor-roller mechanism 4153 is in a third position; FIG. 46 is the axial view of FIG. 43, wherein the arm of first compressor-roller mechanism 4153 is in a fourth position; FIG. 47 is the axial view of FIG. 43, wherein the arm of the first compressor-roller mechanism 4153 is in a fifth position; and FIG. 48 is the axial view of FIG. 43, wherein the arm of the first compressor-roller mechanism 4153 is in a sixth position.

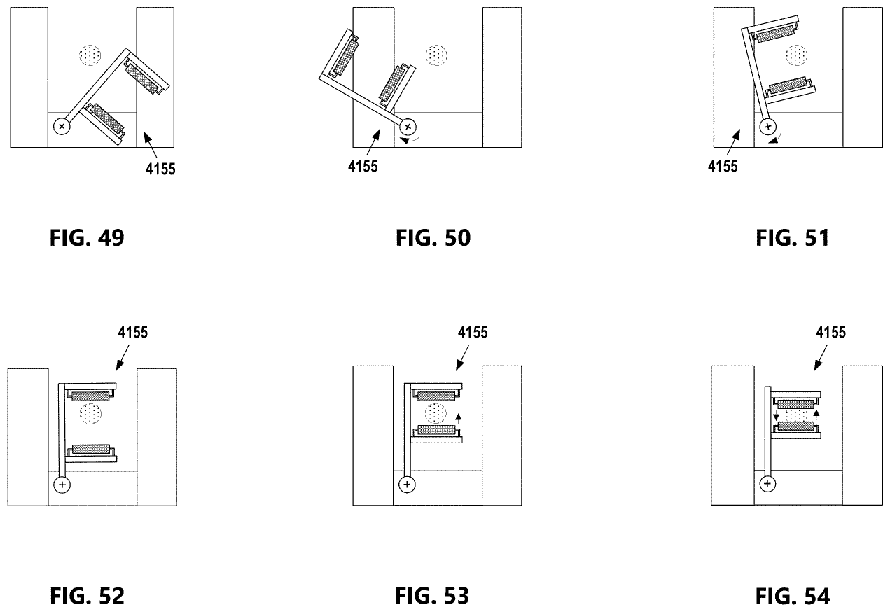

FIG. 49 is an axial view along a cable conductor of a power transmission line of a portion of the revamping apparatus 4010, wherein the arm of the second compressor-roller mechanism 4155 is in a first position; FIG. 50 is the axial view of FIG. 49, wherein the arm of the second compressor-roller mechanism 4155 is in a second position; FIG. 51 is the axial view of FIG. 49, wherein the arm of the second compressor-roller mechanism 4155 is in a third position; FIG. 52 is the axial view of FIG. 49, wherein the arm of the second compressor-roller mechanism 4155 is in a fourth position; FIG. 53 is the axial view of FIG. 49, wherein the arm of the second compressor-roller mechanism 4155 is in a fifth position; and FIG. 54 is the axial view of FIG. 49, wherein the arm of the second compressor-roller mechanism 4155 is in a sixth position.

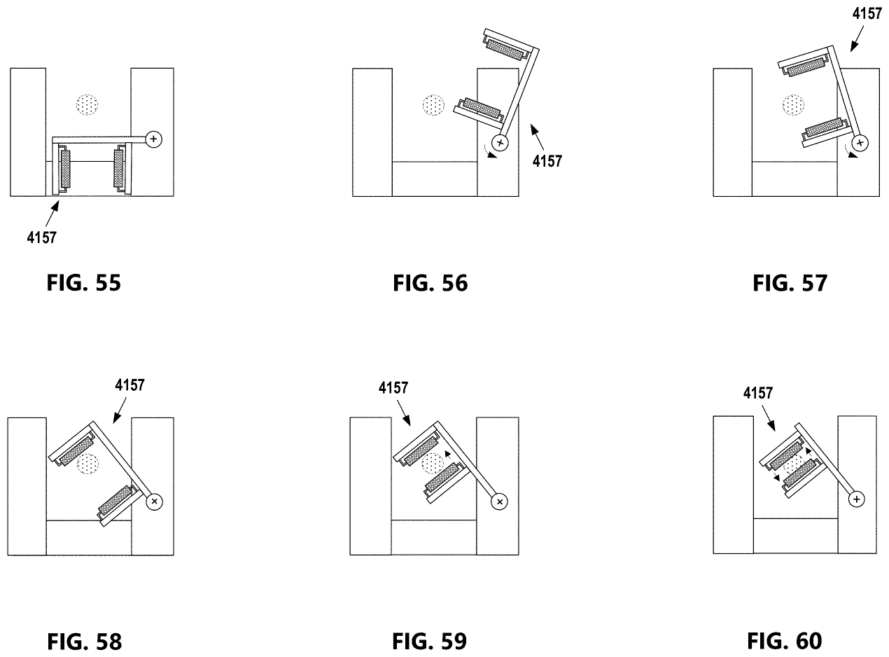

FIG. 55 is an axial view along a cable conductor of a power transmission line of a portion of the revamping apparatus 4010, wherein the arm of the third compressor-roller mechanism 4157 is in a first position; FIG. 56 is the axial view of FIG. 55, wherein the arm of the third compressor-roller mechanism 4157 is in a second position; FIG. 57 is the axial view of FIG. 55, wherein the arm of the third compressor-roller mechanism 4157 is in a third position; FIG. 58 is the axial view of FIG. 55, wherein the arm of the third compressor-roller mechanism 4157 is in a fourth position; FIG. 59 is the axial view of FIG. 55, wherein the arm of the third compressor-roller mechanism 4157 is in a fifth position; and FIG. 60 is the axial view of FIG. 55, wherein the arm of the third compressor-roller mechanism 4157 is in a sixth position.

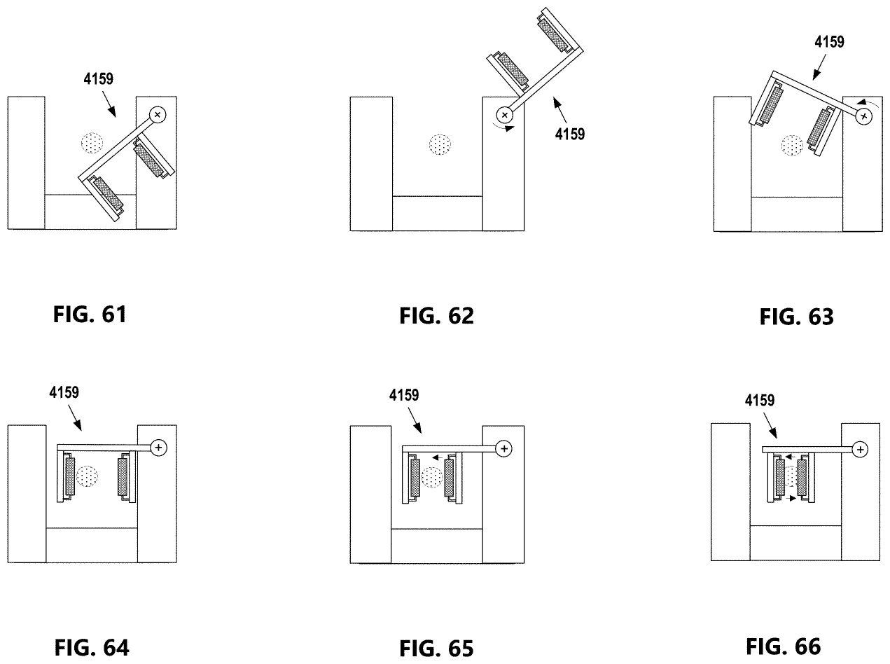

FIG. 61 is an axial view along a cable conductor of a power transmission line of a portion of the revamping apparatus 4010, wherein the arm of the fourth compressor-roller mechanism 4159 is in a first position; FIG. 62 is the axial view of FIG. 61, wherein the arm of the fourth compressor-roller mechanism 4159 is in a second position; FIG. 63 is the axial view of FIG. 61, wherein the arm of the fourth compressor-roller mechanism 4159 is in a third position; FIG. 64 is the axial view of FIG. 61, wherein the arm of the fourth compressor-roller mechanism 4159 is in a fourth position; FIG. 65 is the axial view of FIG. 61, wherein the arm of the fourth compressor-roller mechanism 4159 is in a fifth position; and FIG. 66 is the axial view of FIG. 61, wherein the arm of the fourth compressor-roller mechanism 4159 is in a sixth position.

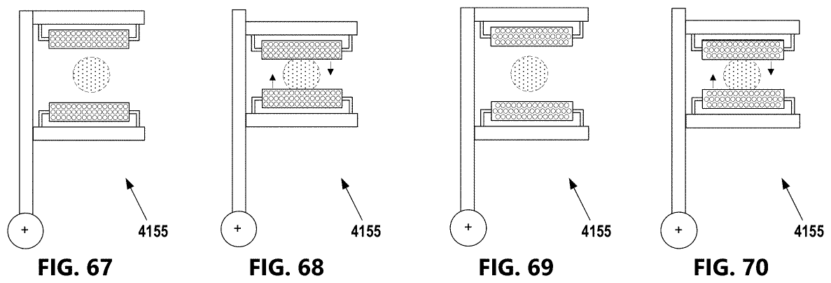

FIG. 67 is an axial view similar to that of FIG. 53, wherein the compressor rollers of the second compressor-roller mechanism 4155 is shown in greater detail to have surface contours configured to form a stack of surface indentations along the cable conductor. FIG. 68 is an axial view similar to that of FIG. 54, wherein the compressor-roller mechanism 4155 is shown in greater detail compressing and debossing the cable conductor using the opposed pair of compressor rollers, thereby forming top and bottom portions of a stack of surface indentations in the exterior surface of the cable conductor.

Similarly, FIG. 69 is an axial view similar to that of FIG. 53, wherein the compressor rollers of the compressor-roller mechanism 4155 is shown to have surface contours configured to form a mesh of surface indentations along the cable conductor; and FIG. 70 is an axial view similar to that of FIG. 54, wherein the compressor-roller mechanism is shown in greater detail compressing and debossing the cable conductor using the opposed pair of compressor rollers, thereby forming top and bottom portions of a mesh of surface indentations in the exterior surface of the cable conductor.

With reference now to FIGS. 71-98, FIG. 71 is a schematic, side elevational view of the revamping apparatus 4010 when approaching an insulator (i.e., insulating support) of the electric power transmission system of FIG. 40, wherein the revamping apparatus is in a configuration for forming surface indentations in a cable conductor.

FIG. 72 is a side view similar to that of FIG. 71, wherein the revamping apparatus has transitioned to a configuration for retracting roller-compressor mechanisms into a housing of the apparatus.

FIG. 73 is a side view similar to that of FIG. 72, wherein the roller-compressor mechanisms are shown being retracted into the housing of the apparatus.

FIG. 74 is a side view similar to that of FIG. 73, wherein the roller-compressor mechanisms are shown being further retracted into the housing of the apparatus.

FIG. 75 is a side view similar to that of FIG. 74, wherein the roller-compressor mechanisms are shown fully retracted into the housing of the apparatus.

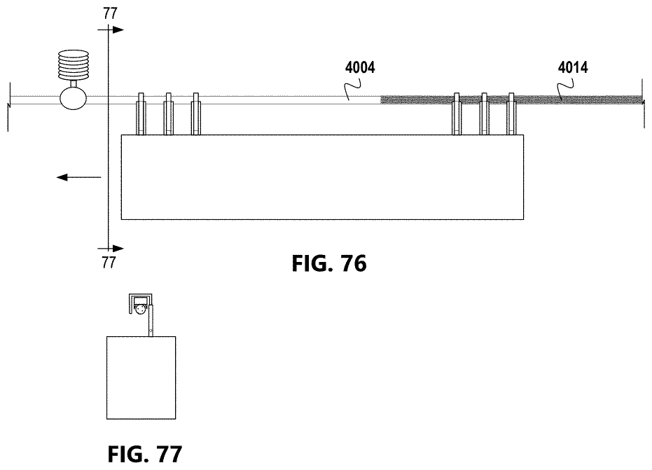

FIG. 76 is a side view similar to that of FIG. 75, wherein the revamping apparatus is shown advancing toward the insulator, and wherein a first, forwardmost suspension arm is shown in a first configuration.

FIG. 77 is an axial view similar to that of FIG. 75, wherein the first, forwardmost suspension arm is shown in the first configuration with a wheel thereof in engagement with the cable conductor.

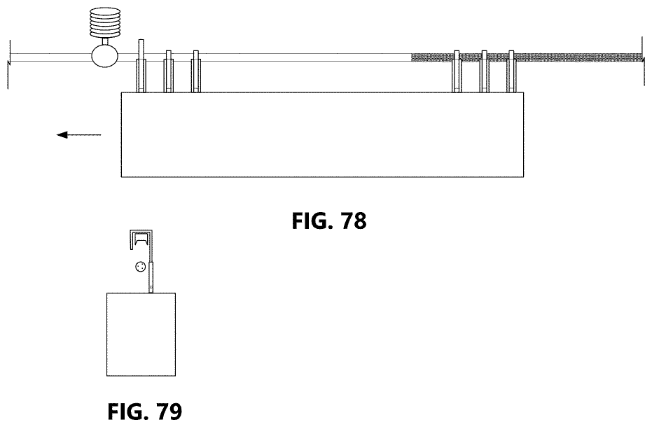

FIG. 78 is a side view similar to that of FIG. 76, wherein the first, forwardmost suspension arm is shown in a second configuration.

FIG. 79 is an axial view similar to that of FIG. 77, wherein the first, forwardmost suspension arm is shown in the second configuration with the wheel thereof out of engagement with the cable conductor.

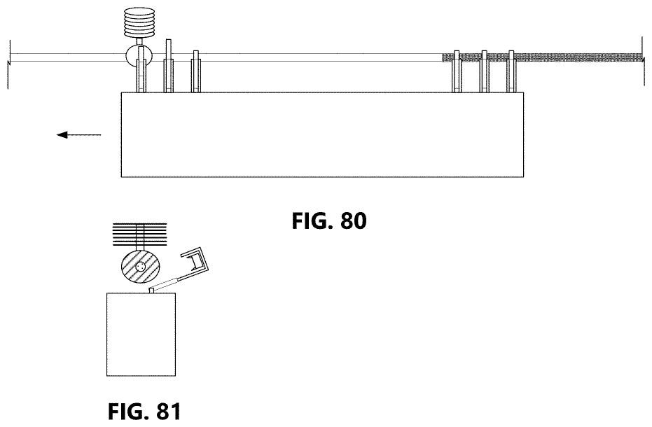

FIG. 80 is a side view similar to that of FIG. 78, wherein the first, forwardmost suspension arm is shown in a third configuration.

FIG. 81 is an axial view similar to that of FIG. 79, wherein the first, forwardmost suspension arm shown in the third configuration is positioned for transitioning past the insulator, as shown in FIG. 80.

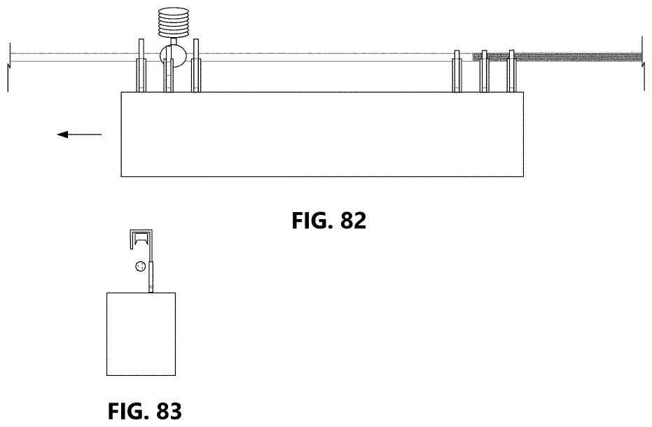

FIG. 82 is a side view similar to that of FIG. 80, wherein the first, forwardmost suspension arm is shown once again in the second configuration.

FIG. 83 is an axial view similar to that of FIG. 81, wherein the first, forwardmost suspension arm is shown again in the second configuration.

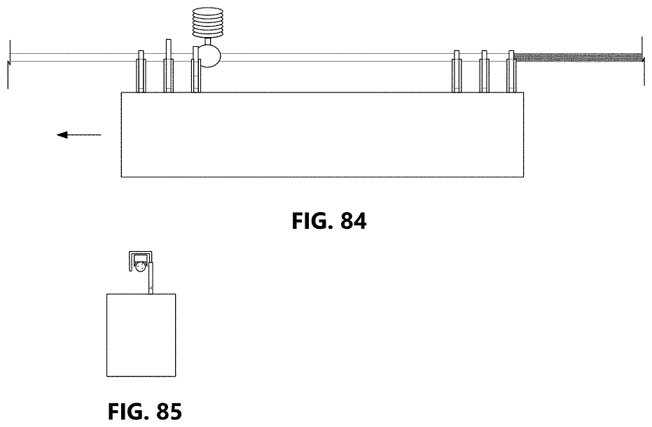

FIG. 84 is a side view similar to that of FIG. 82, wherein the first, forwardmost suspension arm is shown back in the first configuration, with the wheel thereof in engagement with the cable conductor.

FIG. 85 is an axial view similar to that of FIG. 83, wherein the first, forwardmost suspension arm is shown in the first configuration.

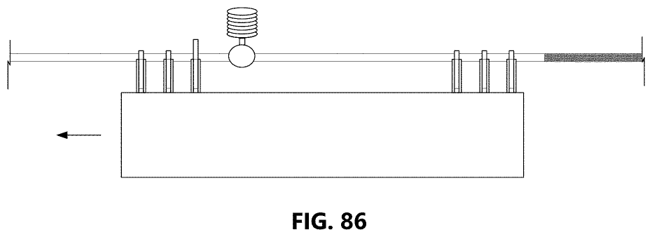

FIG. 86 is a schematic, side elevational view of the revamping apparatus of FIG. 85 as it progresses along the cable conductor, the first three suspension arms having transitioned past the insulator of the electric power transmission system of FIG. 40.

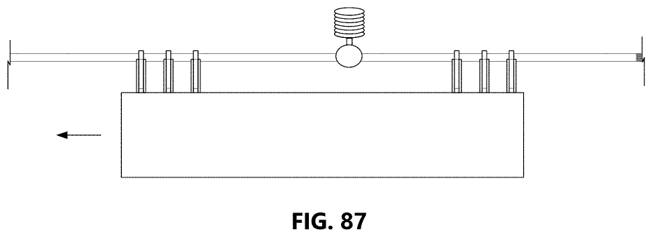

FIG. 87 is a schematic, side elevational view of the revamping apparatus of FIG. 86 as it progresses along the cable conductor, with the next three suspension arms of the revamping apparatus each being in the first configuration in their approach to the insulator of the electric power transmission system of FIG. 40.

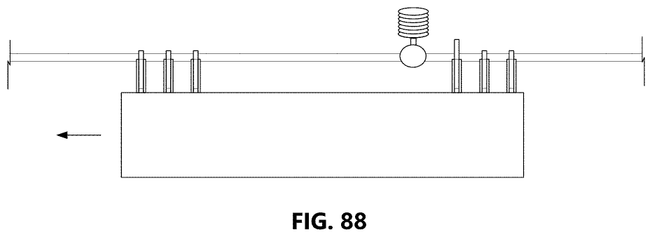

FIG. 88 is a side view similar to that of FIG. 87, wherein the first, forwardmost suspension arm of the next set is shown in the second configuration.

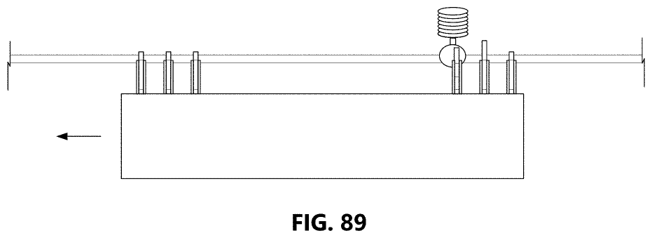

FIG. 89 is a side view similar to that of FIG. 88, wherein the first, forwardmost suspension arm of the next set is shown in the third configuration for transitioning past the insulator, as illustrated therein.

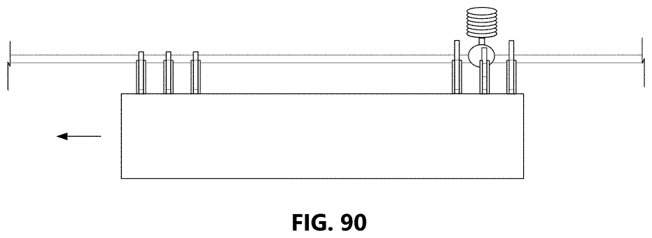

FIG. 90 is a side view similar to that of FIG. 89, wherein the first, forwardmost suspension arm of the next set is shown again in the second configuration.

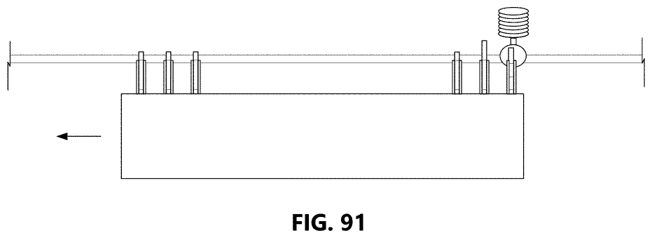

FIG. 91 is a side view similar to that of FIG. 90, wherein the first, forwardmost suspension arm of the next set is shown back in the first configuration.

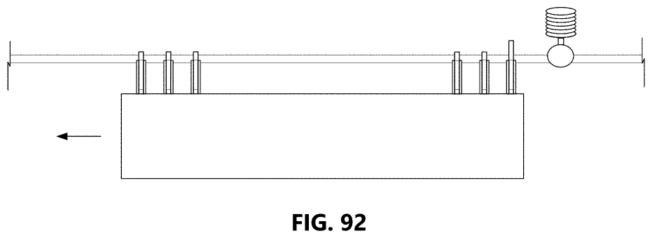

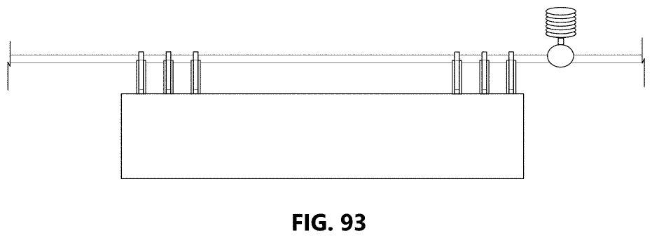

FIG. 92 is a schematic, side elevational view of the revamping apparatus of FIG. 85 after transitioning along the cable conductor past the insulator of the electric power transmission system of FIG. 40. FIG. 93 is a schematic, side elevational view of the revamping apparatus of FIG. 41 after transitioning past the insulator of the electric power transmission system of FIG. 40, wherein the revamping apparatus is ready to transition to a configuration for forming surface indentations in the cable conductor.

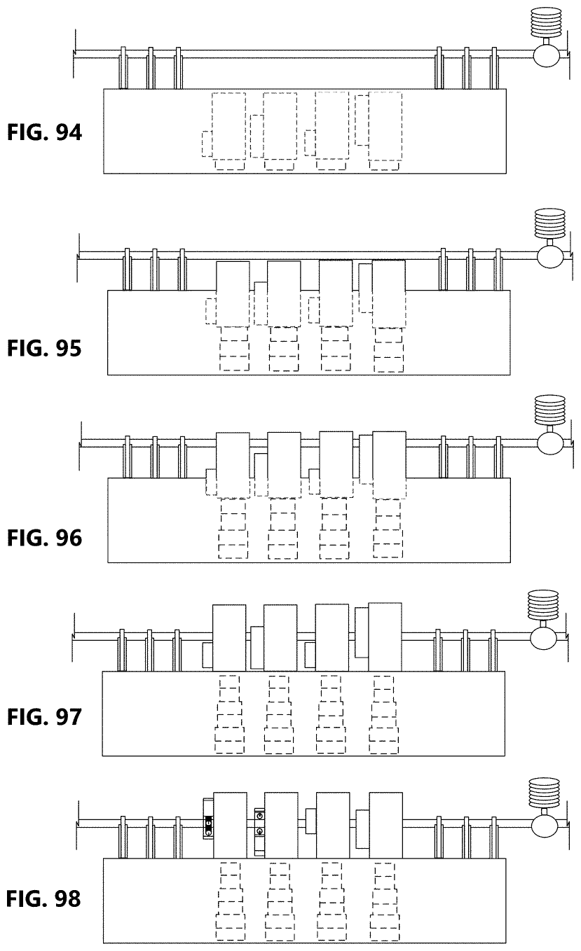

FIG. 94 is another side view similar to that of FIG. 93, wherein the compressor-roller mechanisms are shown in their fully retracted positions within the housing of the revamping apparatus following transitioning of the revamping apparatus past the insulator.

FIG. 95 is a side view similar to that of FIG. 94, wherein the roller-compressor mechanisms are seen being extended from the housing of the revamping apparatus.

FIG. 96 is a side view similar to that of FIG. 95, wherein the roller-compressor mechanisms are seen being further extended from the housing of the revamping apparatus.

FIG. 97 is a side view similar to that of FIG. 96, wherein the roller-compressor mechanisms are fully extended from the housing of the revamping apparatus and are back in a position corresponding to that shown in FIG. 72.

FIG. 98 is a side view similar to that of FIG. 97, wherein the revamping apparatus is shown once again in the configuration for forming surface indentations in a cable conductor, the configuration corresponding to that of FIG. 71.

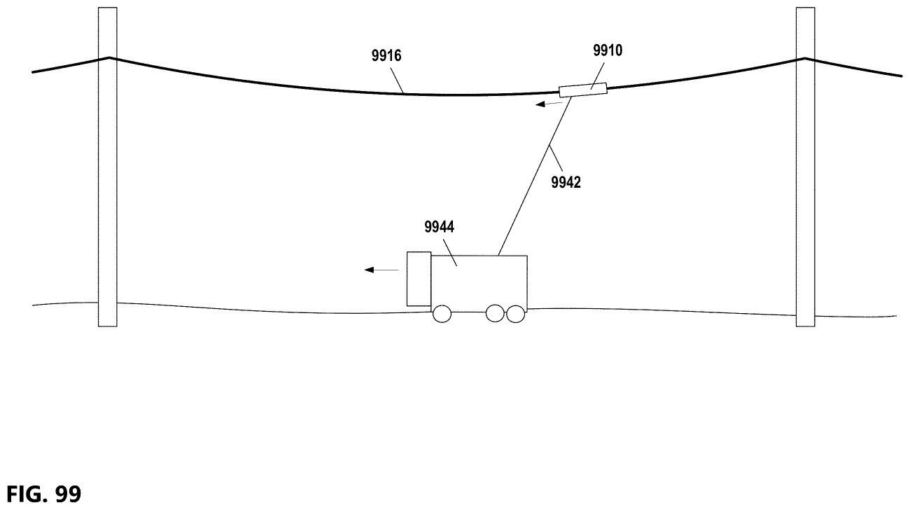

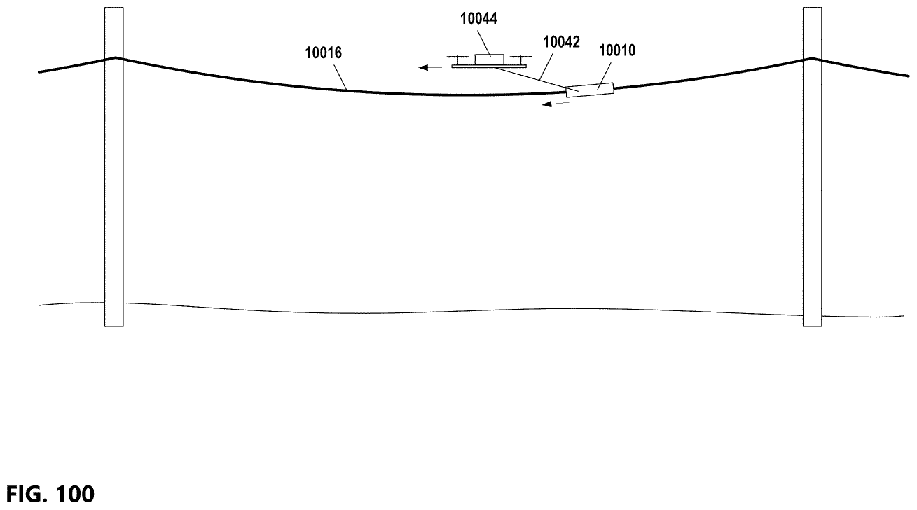

FIG. 99 illustrates another method of revamping electric power transmission lines of a preferred embodiment in accordance with one or more aspects and features of the invention. In this preferred embodiment, a revamping apparatus 9910 is pulled along a cable conductor 9916 and is not self-powered as in the revamping apparatus of 4010. The revamping apparatus 9910 is illustrated as transitioning along the cable conductor by being pulled via a non-conducting pole 9942 by a vehicle 9944. In an alternative embodiment, a revamping apparatus 10010 is pulled by pole or cable 10042 along a cable conductor 10016 by a drone or UAV 10044, as schematically illustrated in FIG. 100. In still other contemplated embodiments, a helicopter rather than UAV is utilized. In still other embodiments, a sandblasting apparatus mounted to a UAV or helicopter is utilized. Other apparatus also may be used in which particles entrained in a fluid (such as air or water) are directed onto the conductor surface, the impact of which forms surface indentations therein.

Based on the foregoing description, it will be readily understood by those persons skilled in the art that the invention has broad utility and application. Many embodiments and adaptations of the invention other than those specifically described herein, as well as many variations, modifications, and equivalent arrangements, will be apparent from or reasonably suggested by the invention and the foregoing descriptions thereof, without departing from the substance or scope of the invention. Accordingly, while the invention has been described herein in detail in relation to one or more preferred embodiments, it is to be understood that this disclosure is only illustrative and exemplary of the invention and is made merely for the purpose of providing a full and enabling disclosure of the invention. The foregoing disclosure is not intended to be construed to limit the invention or otherwise exclude any such other embodiments, adaptations, variations, modifications or equivalent arrangements, the invention being limited only by the claims appended hereto and the equivalents thereof.

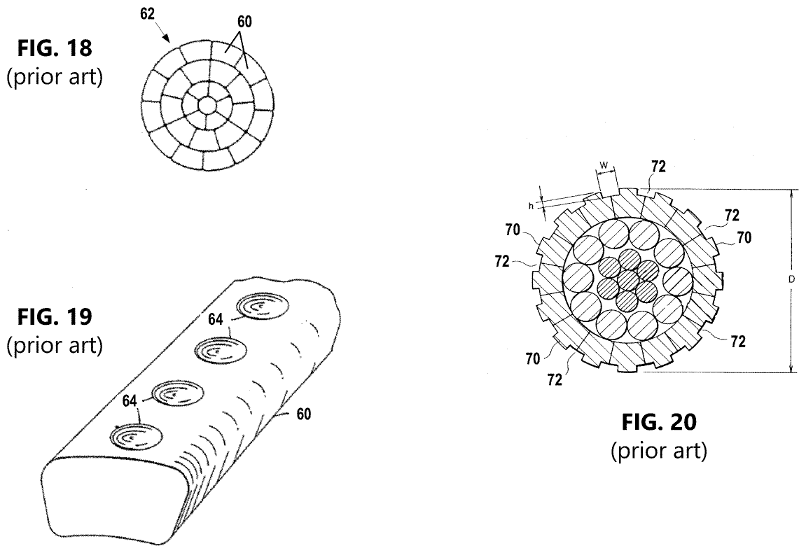

Thus, for example, while strands of the foregoing embodiments of the invention have been illustrated as having oval or circular cross-sectional peripheries, other shapes are within the scope of the invention including, for example, strands having trapezoidal cross-sectional peripheries similar to the trapezoidal cross-sectional periphery shown in FIGS. 18-19.

1. A cable conductor for overhead electric power transmission comprising: a core; and a plurality of strands wound around and enclosing the core and defining an outermost, exposed surface of the cable conductor; wherein an outermost surface of each strand comprises an arrangement of surface indentations extending circumferentially around a longitudinal axis of the strand, and the arrangement repeats along a longitudinal direction of the strand.

2-17. (canceled)

18. A cable conductor according to claim 1, wherein each surface indentation comprises an oval surface indentation having a diameter-to-depth ratio of 13.5 or less.

19. A cable conductor according to claim 1, wherein the arrangements are aligned relative to each other along the longitudinal direction to form a stack pattern.

20. A cable conductor according to claim 1, wherein the arrangements are offset relative to each other along the longitudinal direction to form a mesh pattern.

21-23. (canceled)

24. A cable conductor for overhead electric power transmission comprising a core and a plurality of strands wound around and enclosing the core and defining an outermost, exposed surface of the cable conductor, with an outermost surface of each strand consisting of a dimpled surface.

25. (canceled)

26. A cable conductor according to claim 24, wherein no exposed surface of a strand is smooth.

27-36. (canceled)

37. A cable conductor according to claim 24, wherein each dimpled surface comprises oval surface indentations, with each oval surface indentation having a diameter-to-depth ratio of 13.5 or less.

38. A cable conductor according to claim 24, wherein each strand consists of arrangements of surface indentations that are aligned relative to each other along the longitudinal direction to form a stack pattern.

39-43. (canceled)

44. A cable conductor according to claim 24, wherein unexposed surfaces of the strands are smooth.

45-46. (canceled)

47. A cable conductor for overhead electric power transmission comprising: a core; and a plurality of strands wound around and enclosing the core and defining an outermost, exposed surface of the cable conductor; wherein the outermost, exposed surface of the cable conductor comprises an arrangement of surface indentations extending circumferentially around a longitudinal axis of the cable conductor, and the arrangement repeats along a longitudinal direction of the cable conductor.

48-57. (canceled)

58. A cable conductor according to claim 47, wherein the surface indentations comprise oval surface indentations, with each oval surface indentation having a diameter-to-depth ratio of 13.5 or less.

59. A cable conductor according to claim 47, wherein the arrangements of surface indentations are aligned relative to each other along the longitudinal direction to form a stack pattern.

60. A cable conductor according to claim 47, wherein the arrangements of surface indentations are offset relative to each other along the longitudinal direction to form a mesh pattern.

61-64. (canceled)

65. A cable conductor according to claim 47, wherein unexposed surfaces of the strands are smooth.

66-67. (canceled)

68. A cable conductor for overhead electric power transmission comprising a core and a plurality of strands wound around and enclosing the core and defining an outermost exposed surface of the cable conductor, with the outermost, exposed surface of the cable conductor consisting of dimpled surfaces of the strands.

69-81. (canceled)

82. A cable conductor according to claim 68, wherein each dimpled surface comprises oval surface indentations, with each oval surface indentation having a diameter-to-depth ratio of 13.5 or less.

83-88. (canceled)

89. A cable conductor according to claim 68, wherein unexposed surfaces of the strands are smooth.

90. (canceled)

91. A cable conductor according to claim 68, wherein only exposed surfaces of the strands have surface indentations.

92-515. (canceled)

516. A cable conductor according to claim 68, wherein unexposed surfaces of the strands are smooth.

517. A cable conductor according to claim 68, wherein only exposed surfaces of the strands have surface indentations.
